(19) United States
(12) Patent Application Publication
(10) Pub. No.: US 2026/0086395 A1
(43) Pub. Date: Mar. 26, 2026

(54) MODULATOR, MODULATION SYSTEM, AND TRANSMISSION MODULE

(71) Applicant: NATIONAL INSTITUTE OF ADVANCED INDUSTRIAL SCIENCE AND TECHNOLOGY, Tokyo (JP)

(72) Inventors: Takayuki KUROSU, Tsukuba-shi (JP); Satoshi SUDA, Tsukuba-shi (JP)

(73) Assignee: NATIONAL INSTITUTE OF ADVANCED INDUSTRIAL SCIENCE AND TECHNOLOGY, Tokyo (JP)

(21) Appl. No.: 19/108,819

(22) PCT Filed: Sep. 4, 2023
(86) PCT No.: PCT/JP2023/032257

§ 371 Date: Mar. 5, 2025

(30) Foreign Application Priority Data
Sep. 6, 2022 (JP) 2022-141482

(51) Int. Cl. G02F 1/01; G02B 6/293; H04B 10/50; H04B 10/54; H04B 10/548

(52) U.S. Cl. CPC G02F 1/0113; G02B 6/29343; G02B 6/2938; G02F 1/0121; H04B 10/504; H04B 10/506; H04B 10/54; H04B 10/548; G02F 2203/70

(57) ABSTRACT

A modulator including multiple modulation units each including multiple ring modulators and an output waveguide configured to multiplex beams that have passed through the ring modulators included in the modulation units and output a multiplexed beam. The modulation units each include a sorting waveguide that guides a beam inputted from outside to the ring modulators. All the ring modulators included in the modulation units have resonance frequencies adjusted to differ from each other. A modulator, modulation system, and transmission module for increasing the data communication capacity without having to increase the number of light sources can be provided.

### TECHNICAL FIELD

The present invention relates to a modulator, modulation system, and transmission module related to data communication using light.

### BACKGROUND

The frequency range or power consumption related to data communication has become a limiting factor in increasing the speed and capacity of electronic information processing apparatuses in recent years. To overcome this situation, there has been developed a technology called co-packaging that disposes an electronic circuit and an optical circuit using silicon photonics on the same board to perform data communication using light. The optical circuit here is a circuit in which a semiconductor laser serving as a light source and optical elements such as an optical waveguide and an optical modulator are integrated on a board formed from silicon, a compound semiconductor, or the like, and is disposed close to an electronic circuit. The electronic circuit is configured to apply an electrical signal representing data to the optical modulator of the optical circuit.

For example, Patent Literature 1 discloses a transmission apparatus including multiple photoelectric conversion units that convert a data signal applied from outside into an optical signal having a natural frequency. The transmission apparatus multiplexes optical signals having different frequencies transmitted from the photoelectric conversion units using a multiplexer and transmits the resulting signal. Patent Literature 2 discloses a technology that multiplexes optical signals having multiple different wavelengths into one waveguide. The semiconductor apparatus of Patent Literature 2 is configured to multiplex output beams from semiconductor laser devices into a multi-wavelength beam using a multiplexer.

### PATENT LITERATURE

[Patent Literature 1] Japanese Unexamined Patent Application Publication No. 2010-98166
[Patent Literature 2] Japanese Unexamined Patent Application Publication No. 2015-195271

### SUMMARY

However, conventional systems such as Patent Literature 1 and 2 require the same number of light sources the number of yet-to-be-multiplexed multiple optical as signals, that is, the number of frequencies natural to the optical signals. For example, assuming that the upper limit of the amount of data transmittable by one semiconductor laser is 100 [GB/s], construction of a co-package having a capacity of 10 [TB/s] requires 100 semiconductor lasers.

Under the current circumstances where the data communication capacity is being increased, the capacity required of a co-package is also being increased. Increasing the capacity using any conventional system would inevitably lead to an increase in the number of light sources. This would involve increasing the device size to ensure a space for installing the increased number of light sources, as well as addressing an failure in the individual light sources or the end of life thereof. In particular, in an internal light source-type co-package, semiconductor lasers are affected by high operating temperature, resulting in an increase in the failure rate. This makes it difficult for such a co-package to ensure reliability. For this reason, there is a need for a technology capable of increasing the data communication capacity without having to increase the number of light sources.

The present invention has been made to solve the above problems, and an object thereof is to provide a modulator, modulation system, and transmission module for increasing the data communication capacity without having to increase the number of light sources.

### Solution to Problem

A modulator according to one aspect of the present invention includes multiple modulation units each including multiple ring modulators and an output waveguide configured to multiplex beams passed through the ring modulators included in the modulation units and output a multiplexed beam. The modulation units each include a sorting waveguide configured to guide a beam inputted from outside to the ring modulators. All the ring modulators included in the modulation units have resonance frequencies adjusted to differ from each other.

A modulator according to one aspect of the present invention includes multiple modulation units each including one or more ring modulators and an output waveguide configured to multiplex beams that have passed through the ring modulators included in the modulation units and output a multiplexed beam. The modulation units each include a sorting waveguide configured to guide a beam inputted from outside to the one or more ring modulators. All the ring modulators included in the modulation units have resonance frequencies adjusted to differ from each other. At least one of the modulation units includes the three or more ring modulators having the resonance frequencies adjusted to correspond to three or more different wavelengths. The three or more ring modulators have the resonance frequencies adjusted so that when any two different sets of two wavelengths are selected from the wavelengths corresponding to the resonance frequencies, the two wavelengths forming one of the two sets and the two wavelengths forming the other set have different frequency differences. (The three or more ring modulators have the resonance frequencies adjusted so that a frequency difference of two wavelengths is different in any combination of the wavelengths corresponding to the resonance frequencies.)

A modulation system according to one aspect of the present invention includes the above multiple modulators.

A transmission module according to one aspect of the present invention includes multiple amplifiers directly or indirectly connected to multiple light sources and each configured to amplify an inputted beam and the above modulation system disposed in a subsequent stage of the amplifiers.

A transmission module according to one aspect of the present invention includes a splitter unit connected to multiple light sources and formed by combining multiple splitters, multiple amplifiers configured to amplify multiple beams outputted from the splitter unit, and the above modulation system disposed in a subsequent stage of the amplifiers.

A transmission module according to one aspect of the present invention includes multiple light sources, a splitter unit connected to the light sources and formed by combining multiple splitters, multiple amplifiers configured to amplify multiple beams outputted from the splitter unit, and the above modulation system disposed in a subsequent stage of the amplifiers. The light sources are divided into multiple groups including a group of the three or more light sources. Beams emitted from the three or more light sources included in the group have wavelengths set such that a non-interference condition is satisfied, the non-interference condition being that when any two different sets of two wavelengths are selected from all wavelengths included in a beam inputted to one of the amplifiers, the two wavelengths forming one of the two sets and the two wavelengths forming the other set have different frequency differences (the non-interference condition being that a frequency difference of two wavelengths is different in any combination of wavelengths included in a beam inputted to one of the amplifiers).

A transmission module according to one aspect of the present invention includes multiple light source systems each including a main light source and a backup light source, a splitter unit connected to the light source systems and formed by combining multiple splitters, multiple amplifiers configured to amplify multiple beams outputted from the splitter unit, and the above modulation system disposed in a subsequent stage of the amplifiers. The light source systems each include a selection unit including a first waveguide having one end connected to the main light source and a second waveguide having one end connected to the backup light source. The selection unit includes a switching unit optically coupled to the first waveguide and the second waveguide, a monitoring unit connected to another end of the first waveguide, and a redundant processing unit configured to control the switching unit.

The modulator of the present invention includes the modulation units each including the one or more ring modulators, and the ring modulators have the resonance frequencies adjusted to differ from each other. Thus, the modulator is able to generate a desired signal beam from inputted multiple beams (single-wavelength beams or multi-wavelength beams) and to output it. By using the modulators thus configured in combination, the data communication capacity can be increased without having to increase the number of light sources.

### BRIEF DESCRIPTION OF DRAWINGS

FIG. 1 is a configuration diagram schematically showing a modulator, modulation system, and transmission module according to a first embodiment of the present invention.

FIG. 2 is a configuration diagram showing a specific example of the modulator, modulation system, and transmission module according to the first embodiment of the present invention.

FIG. 3 is a diagram illustrating a modulator including eight modulation units as an example configuration of the modulator shown in FIG. 2.

FIG. 4 is a diagram showing an example configuration of the modulator unit shown in FIG. 3.

FIG. 5 is a configuration diagram schematically illustrating a modulator, modulation system, and transmission module according to a modification 1A of the first embodiment of the present invention.

FIG. 6 is a diagram showing the transfer function of a micro-ring modulator.

FIG. 7 is a configuration diagram showing a specific example of the modulator, modulation system, and transmission module according to the modification 1A of the first embodiment of the present invention.

FIG. 8 is a configuration diagram illustrating an light source system according to a modification 1B of the first embodiment of the present invention.

FIG. 9 is a flowchart showing an example operation related to a redundant processing method using the light source system shown in FIG. 8.

FIG. 10 is a configuration diagram schematically showing a modulator, modulation system, and transmission module according to a second embodiment of the present invention.

FIG. 11 is a configuration diagram showing a specific example of the modulator, modulation system, and transmission module according to the second embodiment of the present invention.

FIG. 12 is a diagram illustrating a modulator including four modulation units as an example configuration of the modulator shown in FIG. 11.

FIG. 13 is a configuration diagram showing an example of a modulator, modulation system, and transmission module according to a third embodiment of the present invention.

FIG. 14 a diagram illustrating the frequency positions of a beam inputted to an SOA and nine FWM beams generated in the SOA.

FIG. 15 is a diagram schematically showing examples of wavelength positions having a narrow occupying frequency range among wavelength positions satisfying a non-interference condition.

FIG. 16 is a diagram showing that the wavelength positions of patterns A to C shown in FIG. 15 satisfy the non-interference condition.

FIG. 17 is a diagram showing that the wavelength positions of patterns D to E shown in FIG. 15 satisfy the non-interference condition.

FIG. 18 is a diagram showing that the wavelength positions of patterns F and G shown in FIG. 15 satisfy the non-interference condition.

FIG. 19 is a diagram showing the generalized configuration of the modulator 60 according to the third embodiment of the present invention.

FIG. 20 is a diagram showing the mode of an input beam associated with each of eight wavelengths divided into two groups so as to satisfy the non-interference condition and the mode of FWM beams.

FIG. 21 is a diagram showing an example configuration of a modulator that generates a WDM signal having eight wavelengths.

FIG. 22 is a diagram showing an example configuration of a modulator that generates a WDM signal having continuous nine wavelengths.

FIG. 23 is a graph showing the results when a laser beam having three wavelengths having equally spaced frequencies is amplified by an SOA.

FIG. 24 is a graph showing the results when a laser beam having four wavelengths having the wavelength positions of a group X shown in FIG. 20 is amplified by an SOA.

FIG. 25 is a graph showing the results when a laser beam having four wavelengths having the wavelength positions of a group Y shown in FIG. 20 is amplified by an SOA.

FIGS. 26A to 26C are diagrams showing changes over time in the intensity of an output beam when each of three laser beams is amplified by an SOA.

FIG. 27 is a configuration diagram schematically showing the modulator, modulation system, and transmission module according to the third embodiment of the present invention.

FIG. 28 is a configuration diagram showing a specific example of the modulation system and transmission module including (4×2) MUXs as modulators according to the third embodiment of the present invention.

FIG. 29 is a configuration diagram showing an specific example of a modulation system and transmission module having a configuration obtained by adding one light source to the light source unit shown in FIG. 28 and including the MUX modulators for nine wavelengths shown in FIG. 22.

FIG. 30 is a configuration diagram showing an example of the modulation system and transmission module including (3×2) MUX modulators as modulators according to the third embodiment of the present invention.

FIG. 31 is a configuration diagram showing another example of the modulation system and transmission module including (3×2) MUX modulators as modulators according to the third embodiment of the present invention.

FIG. 32 is a configuration diagram illustrating an external light source board constituting a part of a transmission module according to a fourth embodiment of the present invention.

FIG. 33 is a configuration diagram illustrating a co-packaged board constituting a part of the transmission module according to the fourth embodiment of the present invention.

FIG. 34 is a configuration diagram illustrating an external light source board constituting a part of a transmission module according to a modification 4A of the fourth embodiment of the present invention.

FIG. 35 is a configuration diagram illustrating a conventional external light source board corresponding to the configuration shown in FIG. 34.

### DETAILED DESCRIPTION

### First Embodiment

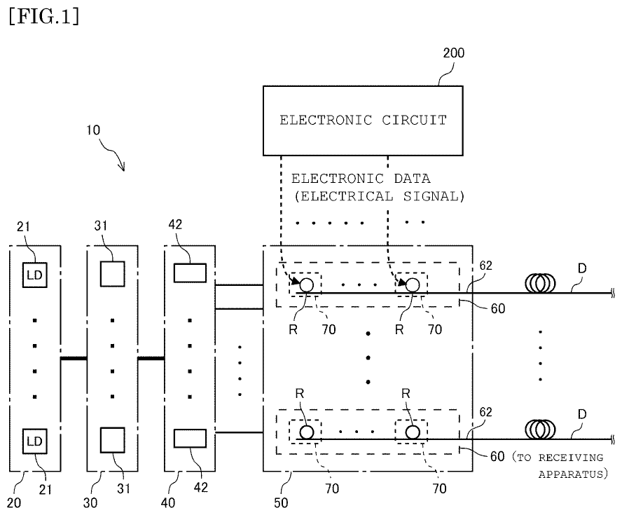

Referring to FIGS. 1 to 4, an example configuration of a modulator 60, a modulation system 50, and a transmission module 10 according to a first embodiment of the present invention will be described. To avoid complication, some of reference signs may be omitted in the drawings. The same applies also to the subsequent drawings.

First, referring to FIG. 1, the overall configuration of the transmission module 10 according to the first embodiment and peripheral devices thereof will be described. As shown in FIG. 1, the transmission module 10 includes a light source unit 20 including multiple light sources 21, a splitter unit 30 including multiple splitters 31, an amplification unit 40 including multiple amplifiers 42, and a modulation system 50 including multiple modulators 60.

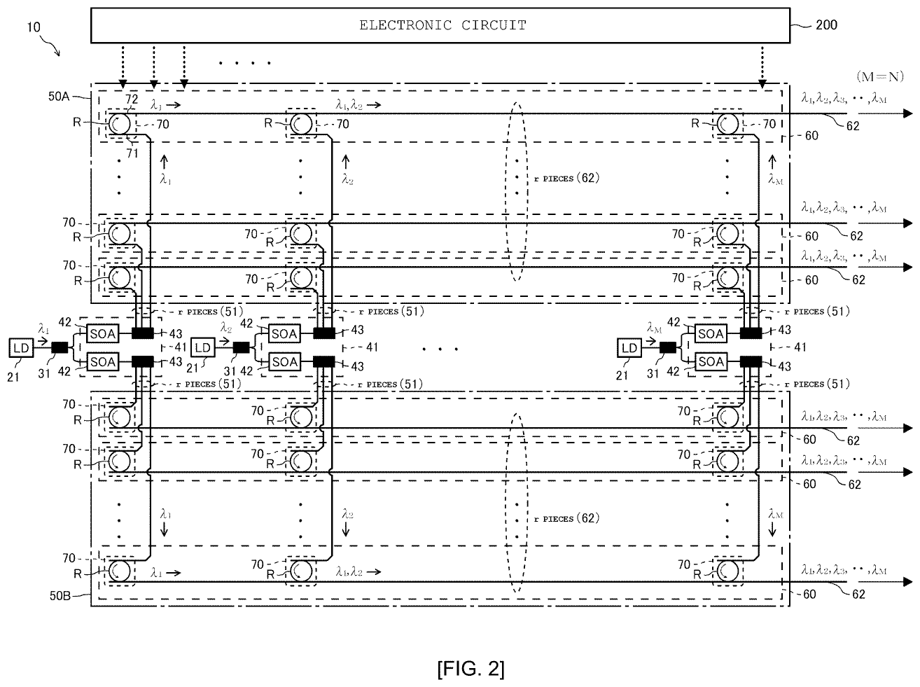

The light sources 21 according to the first embodiment each consist of a laser diode (LD). For this reason, blocks representing the light sources 21 are labeled “LD” in FIGS. 1 and 2. The same applies also to the subsequent drawings. The light source unit 20 includes the light sources 21 that emit beams having different wavelengths. The splitters 31 each include at least one input terminal and two output terminals. The amplifiers 42 according to the first embodiment each consist of a semiconductor optical amplifier (SOA) that amplifies and outputs an inputted beam.

The transmission module 10 according to the first embodiment adopts wavelength division multiplexing (WDM) to increase its capacity, and the modulation system 50, which is an optical integrated circuit using silicon photonics, is disposed near an electronic circuit 200. The modulators 60 of the modulation system 50 are optical modulators for putting information on beams that have been emitted from the light sources 21 and have passed through the splitter unit 30 and amplification unit 40 and have a function of performing photoelectric conversion (photo/electronic conversion) of data. The modulators 60 each convert an electrical signal into an optical signal by applying intensity modulation or phase modulation corresponding to the electrical signal to an input beam having constant intensity.

More specifically, the modulators 60 each include multiple modulation units 70 each including one or more ring modulators R. The ring modulators R are optical devices in charge of photoelectric conversion. In the first embodiment, a micro-ring modulator(s) (MRM(s)) are used as the ring modulators R in terms of downsizing and lower power consumption. In each modulator 60, the ring modulators R have resonance frequencies adjusted to differ from each other.

Each modulator 60 also includes an output waveguide 62 that multiplexes beams that have passed through the ring modulators R and outputs a multiplexed beam. In the modulation system 50, the output waveguides 62 are associated with the modulators 60. Each output waveguide 62 is connected to an optical transmission path D such as an optical fiber. A multi-wavelength signal beam (WDM signal) outputted from each modulator 60 through the output waveguide 62 is transmitted to a receiving apparatus through the optical transmission path D.

An electrical signal representing data to be transmitted is applied to each ring modulator R by the electronic circuit 200. Conceivable examples of the electronic circuit 200 include a switch IC (switch integrated circuit), a central processing unit (CPU), a graphics processing unit (GPU), memory, large-scale integration (LSI), a security operation center (SoC), and the like.

Next, referring to FIG. 2, a specific example of the modulator 60, modulation system 50, and transmission module 10 according to the first embodiment will be described. Note that while broken-line arrows representing electrical signals from the electronic circuit 200 are extending only to one modulator 60 in FIG. 2, the electronic circuit 200 applies electrical signals to all the modulators 60. The same applies also to the subsequent drawings. In the first embodiment, it is assumed that the amplifiers 42 are semiconductor optical amplifiers. For this reason, in FIG. 2, blocks representing the amplifiers 42 are labeled “SOA”. The same applies also to the subsequent drawings.

The modulation system 50 illustrated in FIG. 2 consists of a modulation system 50A and a modulation system 50B. Both the modulation systems 50A and 50B include r modulators 60 (r is any natural number) each including multiple modulation units 70. Therefore, r output waveguides 62 extend from each of the modulation systems 50A and 50B.

In the transmission module 10, the splitters 31 are connected to the multiple light sources 21, and amplification unit 41 is disposed in the subsequent stage of the multiple splitters 31. Each splitter 31 has a function of splitting a beam outputted from a corresponding light source 21 in two directions. Hereafter, a splitter including t input terminals and u output terminals will be referred to as the (txu) splitter. Each splitter 31 consists of, for example, a (1×2) splitter or (2×2) splitter. One output terminal of the splitter 31 is connected to an amplifier 42 associated with the modulation system 50A, and the other output terminal thereof is connected to an amplifier 42 associated with the modulation system 50B.

In the amplification unit 41, the above amplifier 42 associated with the modulation system 50A is connected to a sorter 43 connected to the modulation system 50A, and the other amplifier 42 associated with the modulation system 50B is connected to a sorter 43 connected to the modulation system 50B. Each sorter 43 consists of a (1×r) splitter. The output terminals of the sorter 43 are connected to r input waveguides 51 extending to corresponding modulation units 70.

Each light source 21, which outputs a beam having a wavelength λ_{K} (K=1, 2, . . . , M), is associated with a ring modulator R having a resonance frequency set to “c/λ_{K}” through an amplifier 42 and the like. M is any natural number corresponding to the number of the light sources 21. In each modulator 60, multiple beams having different wavelengths that have entered the modulation units 70 pass through the ring modulators R and are multiplexed in the output waveguide 62. The modulator 60 then outputs a multi-wavelength beam having M wavelengths (λ₁, . . . , λ_{M}). Here, the number of wavelengths of a multi-wavelength beam outputted from each modulator 60 is defined as the multiplexed wavelength count N. In the transmission module 10 according to the first embodiment, the multiplexed wavelength count N is the same as the light source count M, which is the number of the light sources 21. That is, the transmission module 10 generates 2r WDM signals (signals based on wavelength division multiplexing) having the same number of wavelengths as the light source count M.

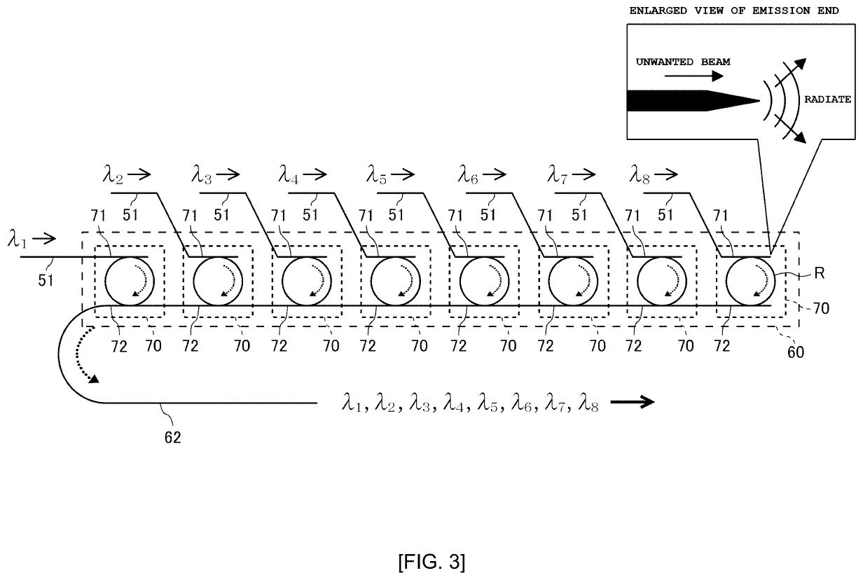

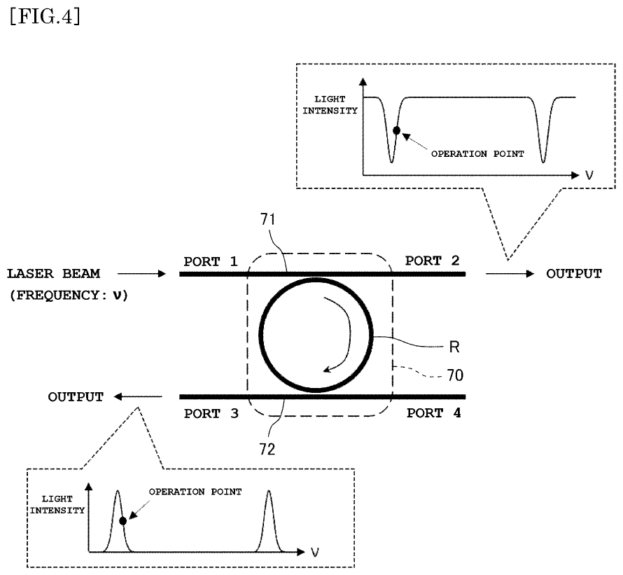

Next, referring to FIGS. 3 and 4, the specific configurations of a modulator 60 and a modulation unit 70 will be described. FIG. 3 shows an example configuration in which a modulator 60 shown in FIG. 2 includes eight modulation units 70. FIG. 4 is an example configuration of a modulation unit 70 shown in FIG. 3.

The modulation units 70 illustrated in FIGS. 3 and 4 each include one ring modulator R, a sorting waveguide 71 that guides a beam inputted from outside to the ring modulator R, and a resonance waveguide 72 that outputs the beam that has passed through the ring modulator R. The sorting waveguide 71 constitutes a part of a corresponding input waveguide 51. The resonance waveguide 72 constitutes a part of the output waveguide 62 of the modulator 60. The ring modulator R, and the sorting waveguide 71 and resonance waveguide 72 are optically coupled to each other.

To avoid oscillation of any amplifier 42 due to a return beam from the modulator 60, the emission end of each input waveguide 51 (the emission end of each sorting waveguide 71) preferably has low reflectance. For that purpose, as shown in an inserted diagram (an enlarged view of an emission end) of FIG. 3, the emission end of each input waveguide 51 may be tapered, for example, by gradually narrowing the width of the emission end, so that the rate of radiation from the emission end is increased. That is, the structure of the emission end of each input waveguide 51 may be changed so that the efficiency of conversion from the eigenmode to the radiation mode is increased. Also, for example, a diffraction grating may be formed on the emission end of each input waveguide 51 or a light absorbing material may be disposed thereon so that oscillation of any amplifier 42 due to a return beam from the modulator 60 is suppressed.

In the case of a configuration in which each modulation unit 70 includes one ring modulator R, as shown in FIG. 4, a port 1 serving as the entrance port of the ring modulator R is disposed on one end of a corresponding sorting waveguide 71, and a port 2 serving as the through port of the ring modulator R is disposed on the other end of the sorting waveguide 71. Also, a port 3 serving as the drop port of the ring modulator R is disposed on one end of the resonance waveguide 72 of the modulation unit 70, and a port 4 serving as the add port of the ring modulator R is disposed on the other end of the resonance waveguide 72.

A laser beam that has entered the modulation unit 70 through the port 1 is emitted from the port 2 unless the frequency thereof is equal to the resonance frequency of the ring modulator R; it is emitted from the port 3 if the frequency is equal to the resonance frequency. The resonance frequency of the ring modulator R can be adjusted by controlling the ambient temperature and/or bias voltage. That is, the resonance frequency of the ring modulator R can be adjusted by at least one of temperature control and voltage control.

As described above, the modulator 60 according to the first embodiment includes the modulation units 70 including one ring modulator R and the output waveguide 62 that multiplexes beams that have passed through the ring modulators R included in the modulation units 70 and outputs a multiplexed beam. Each modulation unit 70 includes the sorting waveguide 71 that guides a beam inputted from outside to the ring modulator R. All the ring modulators R included in the modulation units 70 have resonance frequencies adjusted to differ from each other. Thus, the modulator 60 is able to generate a desired multi-wavelength beam from inputted multiple beams and to output it. By using the modulators 60 thus configured in combination, the data communication capacity can be increased without having to increase the number of light sources.

While the example in which the transmission module 10 includes the splitters 31 (the splitter unit 30) is shown in FIGS. 1 and 2, this is not limiting. For example, the light sources 21 and amplifiers 42 may be configured to be directly connected to each other one-on-one, and the transmission module 10 may be configured to include one of the modulation system 50A and modulation system 50B. Thus, the transmission module 10 can be configured not to include the splitters 31. The transmission module 10 may also be configured not to include the light sources 21.

In other words, the transmission module 10 includes the amplifiers 42 connected to the multiple light sources 21 directly or through the splitters 31 and the modulation system 50 including the modulators 60 and connected to the amplifiers 42 through the sorters 43 including the same number of output terminals as the number of the modulators 60. Thus, the transmission module 10 is able to amplify beams emitted from the light sources 21, to guide the amplified beams to the modulators 60, and thus to generate and output stable multiple WDM signals. The transmission module 10 may include the light sources 21 that are disposed in the front stage of the amplifiers 42 and emit beams having different wavelengths. In this case, the light source count M can be reduced to the same number as the multiplexed wavelength count N. That is, multiple multi-wavelength beams can be generated without having to increase the number of light sources 21, which act as a bottleneck to the longevity of the product.

Light source types for co-packaging include an external light source-type and an internal light source-type. The external light source-type requires introduction of laser beams onto a board using a polarization maintaining fiber (PMF). Unfortunately, this type has hardly been used in optical communication due to the expensiveness of polarization maintaining fibers as a matter of fact. On the other hand, high expectations are being placed on realization of the internal light source-type, in which all components are disposed on a single board, in terms of the ease of the device assembly or operation verification, or the like.

However, an internal light source-type co-package is affected by a temperature increase due to the operation of the implemented components, resulting in an increase in the failure rate of the semiconductor lasers (LDs). A co-package using semiconductor lasers in a number similar to the multiplexed wavelength count has difficulty in ensuring high reliability. Again, assuming that the upper limit of the amount of data transmittable by one semiconductor laser is 100 [GB/s], construction of a co-package having a capacity of 10 [TB/s] requires 100 semiconductor lasers. This means that the failure rate of the product increases by 100 times. Specifically, when 100 semiconductor lasers are mounted on an internal light source-type co-package, the life of the co-package is estimated to be about 2 to 3 years and therefore the co-package lacks reliability as a product.

In this respect, the transmission module 10 according to the first embodiment allows for a reduction in the number of light sources 21 to be used, because it includes the modulation system 50 formed by combining the modulators 60, as well as includes the amplifiers 42 disposed in the front stage of the modulation system 50. Thus, even if the transmission module 10 is configured as an internal light source-type co-package, a reduction in the failure rate and longevity can be realized. Moreover, the transmission module 10 allows the light sources 21 to produce a low output due to its use of the amplifiers 42. Thus, a further reduction in the failure rate and further longevity can be realized.

### <Modification 1A>

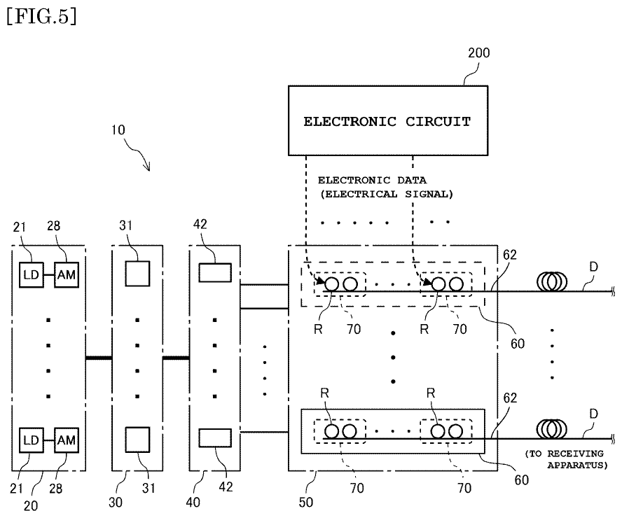

Referring to FIGS. 5 to 7 as well as FIG. 4, a transmission module 10, a modulator 60, and a modulation unit 70 according to a modification 1A of the first embodiment will be described. Components similar to those in the first embodiment are given the same reference signs and will not be described. The transmission module 10 according to the modification 1A doubles the number of modes by applying external modulation to laser beams. Thus, it is able to generate and output beams having the same number of wavelengths as the multiplexed wavelength count N using the number of light sources 21 that is half the multiplexed wavelength count N, where N is an even number, (N/2).

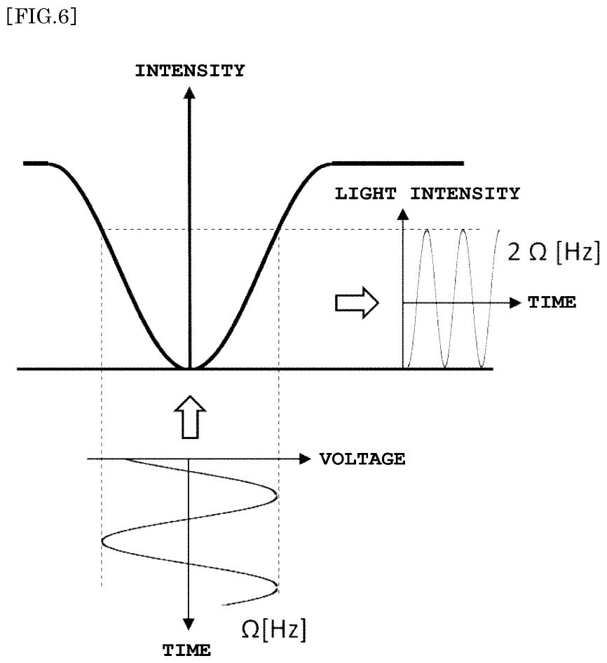

As shown in FIG. 5, a light source unit 20 according to the modification 1A includes multiple intensity modulators 22 associated with multiple light sources 21. Each intensity modulator 22 is configured to generate a new beam having two wavelengths (λ_{K}_{⁽⁺⁾}, λ_{K}⁽⁻⁾) from a beam having a wavelength λ_{K} (K=1, 2, . . . , M, where M is the number of light sources) outputted from a corresponding light source 21. Note that the intensity modulators 22 are configured to perform amplitude modulation (AM) and therefore blocks indicating the intensity modulators 22 are labeled “AM” in FIGS. 5 and 6. The intensity modulators 22 can consist of, for example, micro-ring modulators.

FIG. 6 is a diagram showing the transfer function of a micro-ring modulator. In FIG. 6, the horizontal axis represents the frequency of a laser beam, and the vertical axis represents the intensity of an output beam from the port 2 illustrated in FIG. 4. A point at which output is minimized is selected as an operation point. When the micro-ring modulator is driven using a sine wave having a frequency of Ω, an intensity-modulated beam having a frequency of 2Ω is outputted. This corresponds to that a beam having new two wavelengths (λ_{K}⁽⁺⁾, λ_{K}⁽⁻⁾) having a frequency difference of 2Ω is generated from a laser beam having a wavelength of AK. Note that in the modification 1A, intensity modulation is used as a modulation method on the basis of its advantage that a wide frequency interval is obtained.

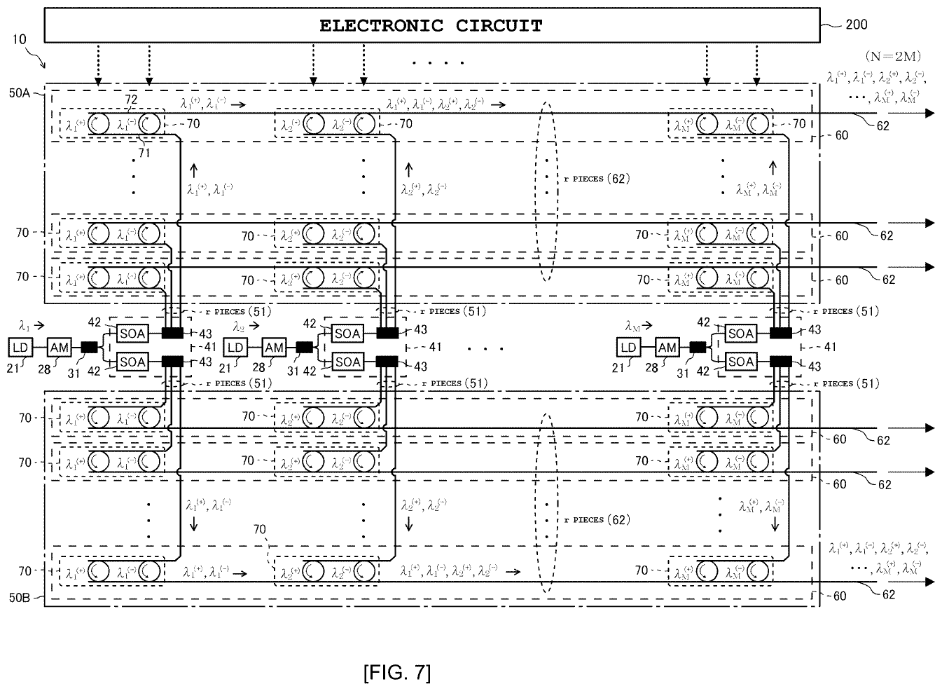

In the transmission module 10 illustrated in FIG. 7, each intensity modulator 22 generates a two-wavelength beam on the basis of a beam emitted from a light source 21 and outputs the two-wavelength beam to a splitter 31 consisting of, for example, a (1×2) splitter. The splitter 31 splits the two-wavelength beam in two directions, and the resulting two-wavelength beams are amplified by amplifiers 42. Then, the amplified two-wavelength beams are each split into r beams by a sorter 43 consisting of a (1×r) splitter, and the r two-wavelength beams are guided to modulation units 70 of corresponding modulators 60. In each modulator 60, two-wavelength beams outputted from the same number of sorters 43 as the light source count M are guided to the modulation units 70 associated with the sorters 43 and modulated thereby, and the beams that have passed through the two ring modulators R of each modulation unit 70 are multiplexed in the output waveguide 62 of the modulator 60. Thus, the transmission module 10 generates and outputs 2r WDM signals having the number of wavelengths that is twice the light source count M. Other and alternative configurations are similar to those in the first embodiment.

As described above, the modulator 60 according to the modification 1A includes the modulation units 70 each including the two ring modulators R and the output waveguide 62 that multiplexes beams that have passed through the ring modulators R included in the modulation units 70 and outputs a multiplexed beam. Each modulation unit 70 includes the sorting waveguide 71 that guides a beam inputted from outside to the ring modulators R. All the ring modulators R included in the modulation units 70 have resonance frequencies adjusted to differ from each other. Thus, the modulator 60 is able to generate a desired multi-wavelength beam from inputted multiple beams and to output it. By using the modulators 60 thus configured in combination, the data communication capacity can be increased without having to increase the number of light sources.

Moreover, in the transmission module 10 according to the modification 1A, the intensity modulators 22 disposed in the subsequent stage of the light sources 21 are each configured to generate a two-wavelength beam from a single-wavelength beam emitted from the corresponding light sources 21. This reduces the number of light sources 21 to be used to half the multiplexed wavelength count and thus further reduces the failure rate and further extends the product life. Mach-Zehnder interferometers, electrolytic absorption modulators (EA modulators), or the like may be used as the intensity modulators 22. However, micro-ring modulators are better in term of downsizing and lower power consumption. Other advantageous effects and the like are similar to those of the first embodiment.

### <Modification 1B>

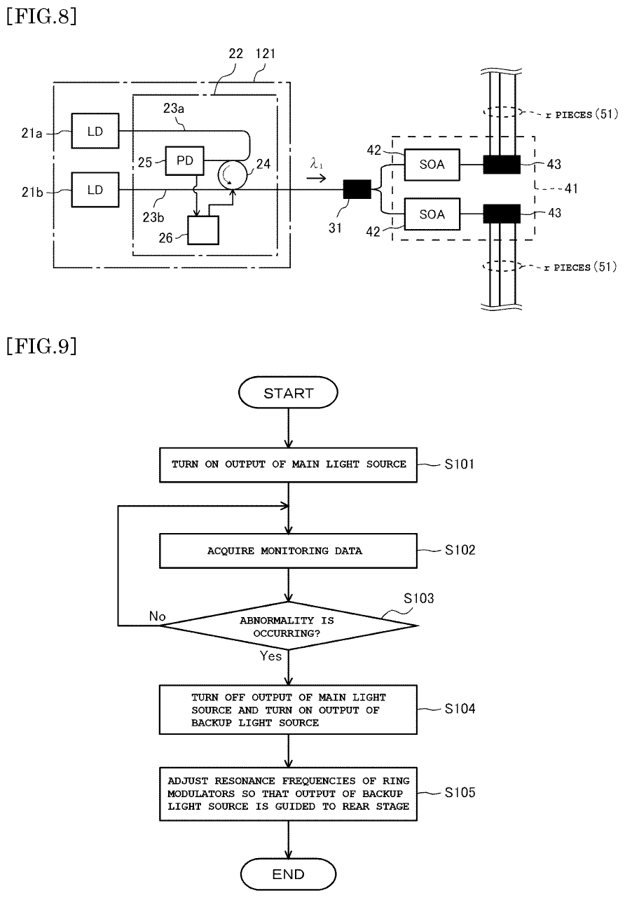

Referring to FIG. 8 as well as FIGS. 2 and 7, an additional configuration of a transmission module 10 according to a modification 1B of the first embodiment will be described. Components similar to those in the first embodiment and modification 1A are given the same reference signs and will not be described. The transmission module 10 according to the modification 1B uses light sources having a redundant configuration. That is, the transmission module 10 according to the modification 1B includes light source systems 121 each including two light sources 21 in place of separate light sources 21.

FIG. 8 shows a light source system 121 illustrated so as to be associated with one light source 21 (a light source that emits a beam having a wavelength λ1) shown in FIG. 2. The light source system 121 includes a light source 21a serving as a main light source, a light source 21b serving as a backup light source, and a selection unit 22 serving as a selector. The selection unit 22 according to the modification 1B includes a ring modulator including two input/output waveguides.

More specifically, the selection unit 22 includes a first waveguide 23a having one end connected to the light source 21a and a second waveguide 23b having one end connected to the light source 21b. The selection unit 22 also includes a switching unit 24 optically coupled to the first waveguide 23a and second waveguide 23b, a monitoring unit 25 connected to the other end of the first waveguide 23a, and a redundant processing unit 26 for controlling the switching unit 24.

In the modification 1B, the switching unit 24 consists of a micro-ring resonator. The monitoring unit 25 consists of a photodiode (PD). For this reason, a block representing the monitoring unit 25 in FIG. 8 is labeled “PD”. The monitoring unit 25 always monitors the output of the light source 21a, as well as transmits monitoring data indicating the output of the light source 21a to the redundant processing unit 26. The redundant processing unit 26 adjusts the resonance frequency of the switching unit 24 on the basis of the monitoring data transmitted from the monitoring unit 25. The other end of the second waveguide 23b is connected to a splitter 31 in the subsequent stage.

When applying the configuration of the modification 1B to the transmission module 10 according to the first embodiment as shown in FIG. 2, light source systems 121 as illustrated in FIG. 8 are mounted in place of all the light sources 21. The configuration according to the modification 1B may also be applied to the configuration of the modification 1A. In this case, light source systems 121 as shown in FIG. 8 are mounted in place of all the light sources 21 of the transmission module 10 according to the modification 1A as shown in FIG. 7.

During normal operation, the redundant processing unit 26 turns on only the light source 21a connected to the first waveguide 23a and turns off the light source 21b. The redundant processing unit 26 tunes the resonance frequency of the switching unit 24 with the oscillation frequency of the light source 21a so that the output of the light source 21a is guided to the splitter 31 through the switching unit 24.

The redundant processing unit 26 sequentially acquires monitoring data from the monitoring unit 25 and detects whether an abnormality is present in the light source 21a, on the basis of the acquired monitoring data. When the redundant processing unit 26 detects an abnormality in the light source 21a, it turns off the output of the light source 21a and turns on the output of the light source 21b. At this time, the redundant processing unit 26 shifts the resonance frequency of the switching unit 24 from the oscillation frequency of the light source 21b so that the output of the light source 21b is guided to the splitter 31.

The redundant processing unit 26 consists of a microcontroller or the like including a calculation device such as a central processing unit (CPU) and storage devices such as random access memory (RAM) and read-only memory (ROM). That is, the redundant processing unit 26 can consist of the calculation device such as CPU and a redundant processing program that performs the above or below functions in collaboration with such a calculation device (the operation program of the redundant processing unit 26).

While the example in which the redundant processing unit 26 is provided for each light source system 121 is shown in FIG. 8, this is not limiting. The redundant processing unit 26 may be configured to centrally control the light source systems 121 of the transmission module 10. For example, the transmission module 10 as shown in FIG. 2 or 7 may include a redundant processing unit 26 for centrally controlling the modulation system 50A and a redundant processing unit 26 for centrally controlling the modulation system 50B, or may include one redundant processing unit 26 for centrally controlling the entire system. Other and alternative configurations are similar to those in the first embodiment and modification 1A.

Next, referring to the flowchart of FIG. 9, an example operation of the redundant processing unit 26 according to a redundant processing method according to the modification 1B will be described. When the transmission module 10 is started, for example, by turning on the power, the redundant processing unit 26 turns on the output of the light source 21a, which is the main light source (step S101).

The redundant processing unit 26 then sequentially acquires monitoring data transmitted from the monitoring unit 25 (step S102) and determines whether an abnormality is occurring in the light source 21a, on the basis of the acquired monitoring data. For example, information on the normal range of monitoring data may be previously stored in a storage device or the like so that falling of monitoring data outside the normal range is associated with occurrence of an abnormality in the light source 21a. Note that to avoid an erroneous determination due to an external factor, the lower limit threshold of the frequency of succession of data outside the normal range, the lower limit threshold of the continued time of such data, or the like may be set so that a sporadic and temporary data variation does not affect abnormality detection. Abnormality trend information indicating the variation trend of monitoring data when an abnormality occurs in a light source may be previously stored in a storage device or the like so that the redundant processing unit 26 makes the above abnormality determination by comparing monitoring data acquired over time and the abnormality trend information. The redundant processing unit 26 may also make the abnormality determination using an estimation model based on machine learning (step S103).

The redundant processing unit 26 continues to analyze sequentially acquired monitoring data until it determines that an abnormality is occurring in the light source 21a (No in step S102, step S103). When the redundant processing unit 26 determines that an abnormality is occurring in the light source 21a (Yes in step S103), it turns off the output of the light source 21a, which the main light source, and turns on the output of the light source 21b, which is the backup light source (step S104). The redundant processing unit 26 also adjusts the resonance frequency of the switching unit 24 so that the output of the light source 21b, which is the backup light source, is guided to the subsequent stage. Specifically, the redundant processing unit 26 adjusts the resonance frequency of the switching unit 24 to a frequency different from the oscillation frequency of the light source 21b so that a beam emitted from the light source 21b does not flow into the switching unit 24 (step S105). Note that the redundant processing unit 26 may perform step S104 and step S105 in parallel or may perform these steps in a reverse order.

As described above, the transmission module 10 according to the modification 1B includes the light source systems 121 each including the usually used main light source (the light source 21a) and the backup light source (the light source 21b) provided as a backup of the main light source. Each light source system 121 includes the monitoring unit 25 that transmits monitoring data indicating the output of the main light source and the switching unit 24 for switching between the main light source and backup light source. The light source system 121 also includes the redundant processing unit 26 that switches between the main light source and backup light source when it detects an abnormality in the main light source from monitoring data transmitted from the monitoring unit 25. Thus, when an abnormality occurs in the main light source, the light source system 121 is able to continue to emit a beam using the backup light source. This means the redundancy of light sources, which act as a bottleneck to the longevity of the product. The light source systems 121 according to the modification 1B thus configured allow for further extension of the product life.

While a micro-ring modulator is illustrated as the switching unit 24 in the modification 1B, this is not limiting. Any other type of modulator such as a Mach-Zender modulator, which is a modulator using a Mach-Zender interferometer, may be used as the switching unit 24. However, a micro-ring modulator is better as the switching unit 24 in terms of downsizing and cost reduction. A transmission module 10 may be configured as a combination of the configuration of the modification 1B and the configuration of the modification 1A. Other advantageous effects and the like are similar to those of the first embodiment and modification 1A.

### Second Embodiment

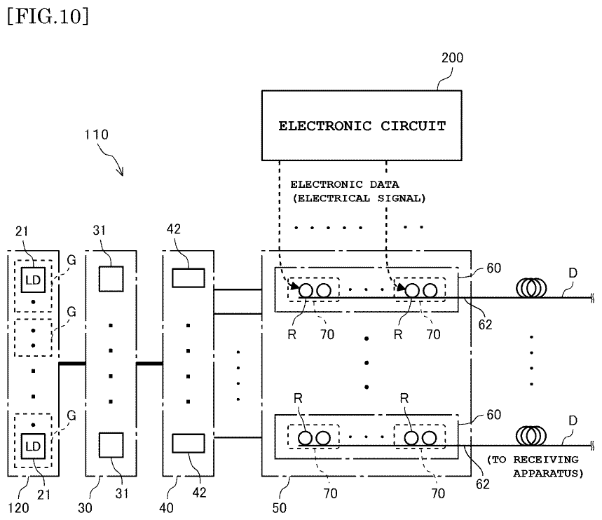

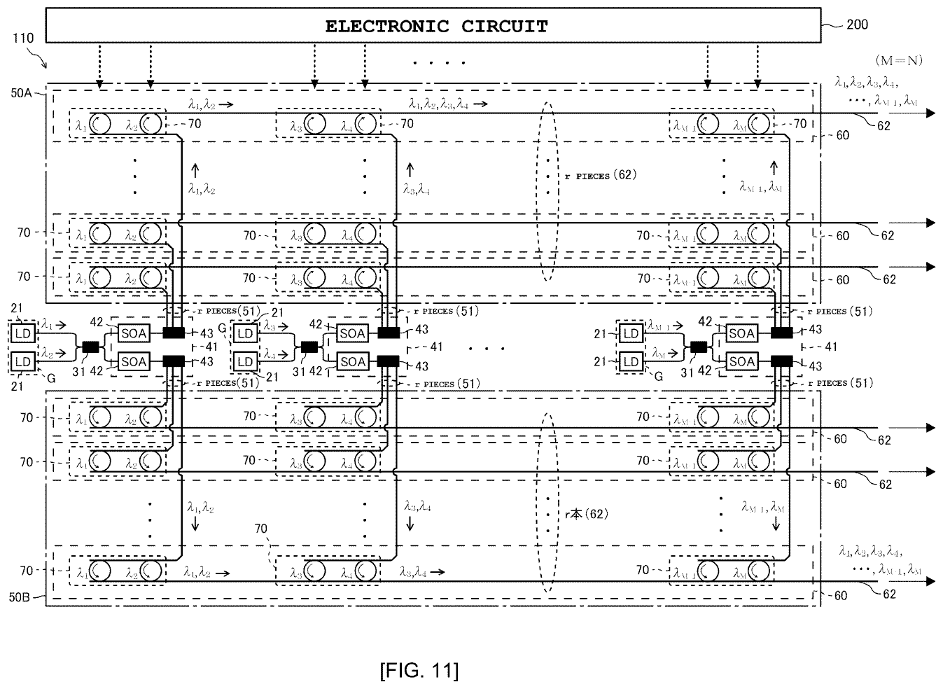

Referring to FIGS. 10 to 12, a transmission module 110, a modulator 60, and a modulation unit 70 according to a second embodiment of the present invention will be described. Components similar to those in the first embodiment are given the same reference signs, and the description thereof will be omitted or simplified.

First, referring to FIG. 10, the overall configuration of the transmission module 110 according to the second embodiment and peripheral devices thereof will be described. As shown in FIG. 10, the transmission module 110 includes a light source unit 120 including multiple light sources 21, a splitter unit 30 including multiple splitters 31, an amplification unit 40 including multiple amplifiers 42, and a modulation system 50 including multiple modulators 60.

The light source unit 120 according to the second embodiment includes the light sources 21 that emit beams having different wavelengths, and the light sources 21 are divided into groups of two light sources. Each group of two light sources 21 are connected to a common splitter 31. The groups of two light sources 21 are referred to as the light source groups G. The modulators 60 according to the second embodiment each include multiple modulation units 70 each including two ring modulators R. That is, the number of ring modulators R of each modulation unit 70 is the same as the number of light sources 21 forming each light source group G.

Next, referring to FIG. 11, a specific example of the modulators 60, modulation system 50, and transmission module 110 according to the second embodiment will be described. In the transmission module 110, two light sources 21 forming each light source group G are connected to a splitter 31 consisting of a (2×2) splitter. The splitter 31 has a function of combining beams outputted from the two light sources 21 and splitting the combined beam in two directions, and two output terminals of the splitter 31 are connected to different amplifiers 42. Each amplifier 42 is connected to a sorter 43 consisting of, for example, a (1×r) splitter. The output terminals of the sorter 43 are connected to input waveguides 51 extending to corresponding modulation units 70.

A light source 21 having a wavelength λ_{K} and a light source 21 having a wavelength λ_{K+1} forming one of the light source groups G are associated with two ring modulators R in a modulation unit 70 associated with the one light source group G. Thus, in each modulator 60, a beam having a wavelength λ_{K} and a beam having a wavelength λ_{K+1} that have entered each modulation unit 70 pass through the two ring modulators R thereof and are multiplexed in the output waveguides 62 of the modulator 60. The modulator 60 then outputs a multi-wavelength beam having M wavelengths (λ₁, . . . , λ_{M}). In the transmission module 110 according to the second embodiment, the multiplexed wavelength count N and the light source count M are equal. That is, the transmission module 110 generates 2r WDM signals having the same number of wavelengths as the light source count M.

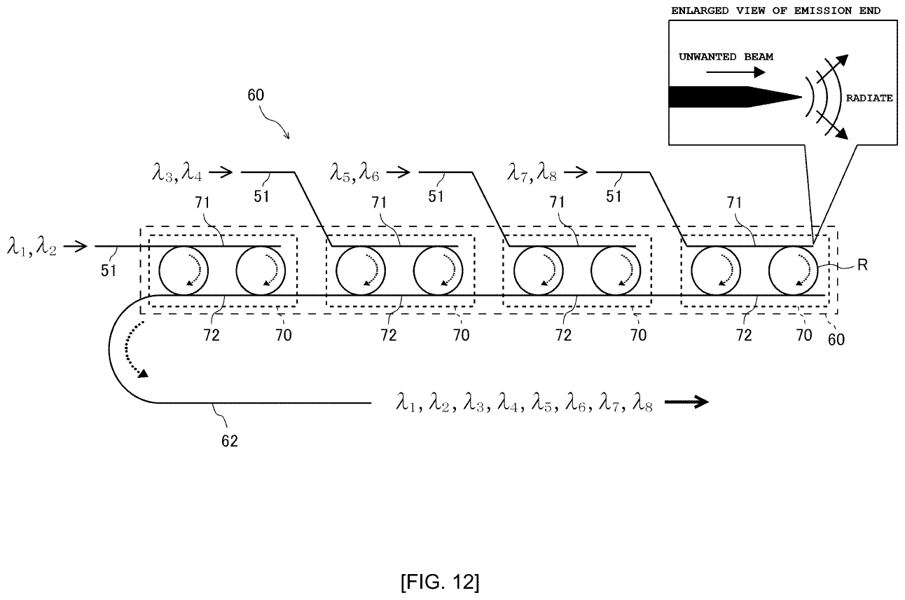

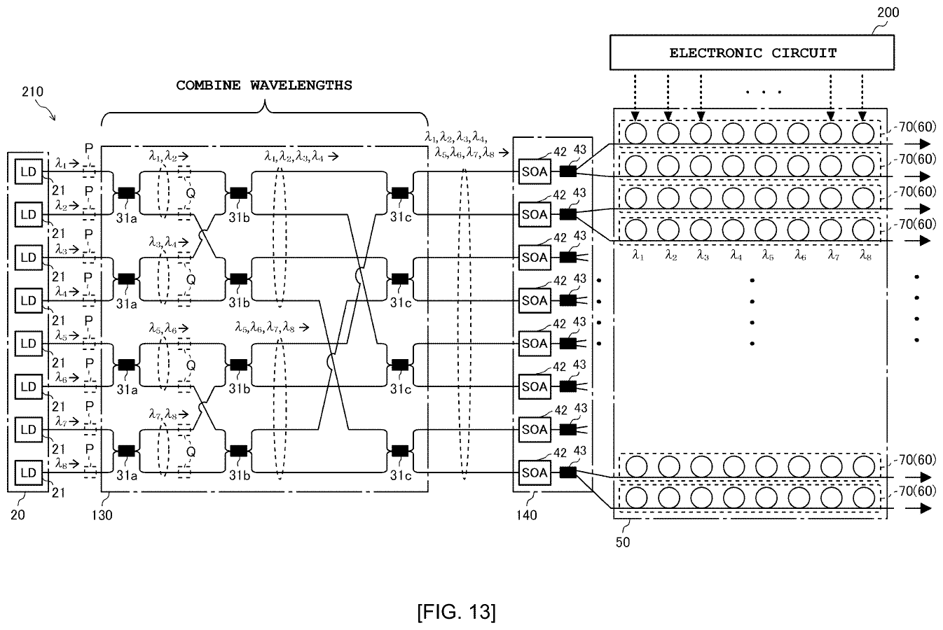

Next, referring to FIG. 12, a specific example of a modulator 60 and modulation units 70 will be described. FIG. 12 shows an example configuration in which a modulator 60 shown in FIG. 11 includes four modulation units 70. The modulation units 70 illustrated in FIG. 12 each include two ring modulators R, a sorting waveguide 71 that guides a beam inputted from outside to the ring modulators R, and a resonance waveguide 72 that outputs the beam that has passed through the ring modulators R. As described above with reference to FIG. 3, the structure of the emission end of each input waveguide 51 (each sorting waveguide 71) may be changed so that the efficiency of conversion from the eigenmode to the radiation mode is increased (see an inserted diagram). Also, to suppress the oscillation of any amplifier 42 due to a return beam from the modulator 60, a diffraction grating may be formed on the emission end of each input waveguide 51, or a light absorbing material may be disposed on the emission end. Other and alternative configurations are similar to those in the first embodiment.

As described above, the modulator 60 according to the second embodiment includes the modulation units 70 each including the two ring modulators R and the output waveguide 62 that multiplexes beams that have passed through the ring modulators R included in the modulation units 70 and outputs a multiplexed beam. Each modulation unit 70 includes the sorting waveguide 71 that guides a beam inputted from outside to the ring modulators R. All the ring modulators R included in the modulation units 70 have resonance frequencies adjusted to differ from each other. Thus, the modulator 60 is able to generate a desired multi-wavelength beam from inputted multiple beams and to output it. By using the modulators 60 thus configured in combination, the data communication capacity can be increased without having to increase the number of light sources. Other advantageous effects and the like are similar to those of the first embodiment. The configuration of the modification 1A or modification 1B may be applied to the configuration of the second embodiment. Note that if the configuration of the modification 1A is applied, it is necessary to note occurrence of four-wave mixing.

### Third Embodiment

Referring to FIGS. 13 to 32, a transmission module 210 according to a third embodiment of the present invention will be described. The transmission module 210 according to the third embodiment is characterized in that at least one of modulation units 70 constituting each modulator 60 includes three or more ring modulators R. Components similar to those in the first and second embodiments are given the same reference signs, and the description thereof will be omitted or simplified.

For example, when generating multiple multi-wavelength beams whose multiplexed wavelength count N is 8 (8-wavelength beams), a configuration as shown in FIG. 13 is conceivable. A transmission module 210 illustrated in FIG. 13 includes a light source unit 20 including multiple light sources 21, a splitter unit 130 including multiple splitters 31, an amplification unit 140 including multiple amplifiers 42, and a modulation system 50 including multiple modulators 60.

The splitter unit 130 has a configuration in which the splitters 31 consisting of (2×2) splitters are cascade-connected (multi-stage connected). For example, when the multiplexed wavelength count N is set to an integer of 3 or more that can be expressed as a power of 2, that is, as N=2^{R} (R is an integer of 2 or more), the splitter unit 130 can have a configuration in which the splitters 31 are cascaded in R stages. R is an index when the multiplexed wavelength count N is expressed as a power of 2. The splitter unit 130 thus configured is able to combine N laser beams emitted from the light sources 21 at the same ratio without waste.

That is, FIG. 13 illustrates the basic configuration of a co-package using the amplifiers 42 when the multiplexed wavelength count N is 8 (R=3). The transmission module 210 illustrated in FIG. 13 includes the same number of light sources 21 and amplifiers 42 as the multiplexed wavelength count N. More specifically, the transmission module 210 includes eight light sources 21 that emit beams having different wavelengths, a splitter unit 130 including multiple splitters 31 cascaded in three stages, and an amplification unit 140 including eight amplifiers 42.

Of the splitters 31 of the splitter unit 130 shown in FIG. 13, splitters 31 in the first stage of the three-stage cascade are referred to as the splitters 31a, splitters 31 in the second stage as the splitters 31b, and splitters 31 in the third stage as the splitters 31c. The two input terminals of each splitter 31a are connected to different light sources 21. The splitter 31a is configured to combine beams having different wavelengths emitted from the light sources 21 and to output the resulting two-wavelength beam to different splitters 31b. Each splitter 31b is configured to combine different two-wavelength beams emitted from two splitters 31a and to output the resulting four-wavelength beam to different splitters 31c. Each splitter 31c is connected to two splitters 31b so that it receives different four-wavelength beams. The splitter unit 130 thus configured is able to generate eight eight-wavelength beams.

The two output terminals of each splitter 31c are connected to different amplifiers 42. In an example in FIG. 13, the amplifiers 42 are connected to sorters 43 consisting of (1×2) splitters, and the sorters 43 are connected to a modulation system 50 consisting of a combination of multiple modulators 60. That is, the eight multi-wavelength beams outputted from the splitter unit 130 are amplified by the amplifiers 42 and then each split to two beams, which are then guided to the modulators 60 constituting the modulation system 50.

Eight ring modulators R are disposed on each of the waveguides of the modulators 60, and the i-th (i is any natural number equal to or smaller than 8) ring modulator R has a resonance frequency set such that intensity modulation is applied only to the output of the i-th light source 21. That is, the light sources 21 constituting the light source unit 20 and the ring modulators R of the modulators 60 are associated with each other one-on-one. When “112 Gbit/s-PAM4” is used as a signal modulation format, WDM signals having a capacity of 14.336 TB/s (112 Gbit/s×8 waves×16=14.336 TB/s) can be generated using only the eight light sources 21. If the number of beams: into which the beam outputted from each amplifier 42 is split is increased, that is, if (1×z) splitters (z is an integer equal to or greater than 3) are used as the sorters 43, the capacity can be further increased.

While the example configuration in which the amplifiers 42 are disposed between the splitter unit 130 and sorters 43 is shown in FIG. 13, the number and disposition of the amplifiers 42 are not limited to this example. For example, when input beams are significantly lost in the modulation system 50 and thus sufficient signal light intensity is no longer obtained, the amplifiers 42 may be disposed immediately after the sorters 43 rather than immediately before them so that input beams are amplified in the waveguides of the modulation system 50. When beams are significantly lost in the splitters 31 (31a to 31c) used to combine beams, the amplifiers 42 may be disposed before or after the splitters 31 (for example, in positions P or positions Q) so that the losses are compensated for. This eliminates the need to cause the light sources 21 to produce a high output and therefore is advantageous in extending the product life. Note that amplifiers 42 may be disposed immediately before or immediately after the sorters 43, as well as in the positions P or positions Q. That is, in the transmission module 210, a required number of amplifiers 42 may be disposed in suitable positions in accordance with losses of beams in the components, or the like.

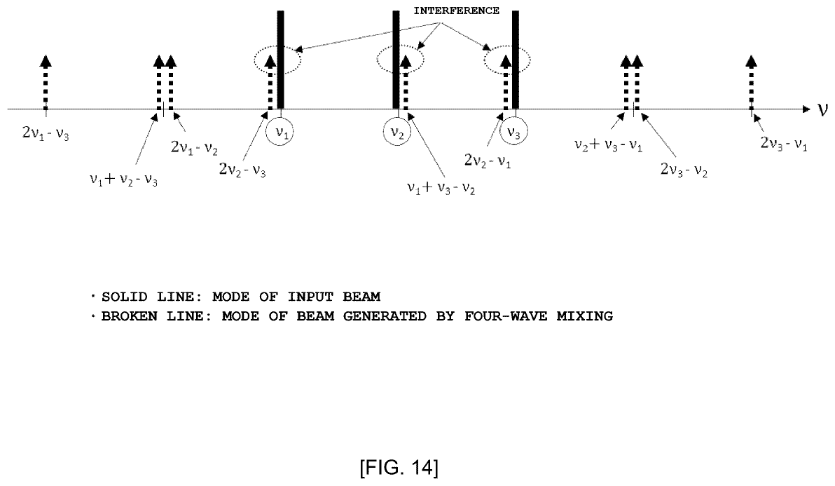

Next, referring to FIGS. 14 to 26, features of the transmission module 210 according to one aspect of the third embodiment will be described. A problem of a semiconductor optical amplifier (SOA) is that non-linear optical effects occur when the intensity of a beam is increased. In particular, when a multi-wavelength beam having three or more wavelengths is amplified by an SOA, multiple four-wave mixing (FWM) processes proceed and the output often becomes unstable or highly noisy. For this reason, in the case of a configuration in which multi-wavelength beams having three or more wavelengths are amplified by the amplifiers 42, as shown in FIG. 13, it is necessary to cause the light sources 21 to produce a low output so that interference. In this case, it is necessary to compensate for reductions in the outputs of the light sources 21 by disposing more amplifiers 42 than those in the example shown in FIG. 13 in various positions, so that electrical signals from the electronic circuit 200 are favorably transferred.

However, as long as a measure to suppress the influence of FWM is taken, no problem will occur even when the amplifiers 42 are caused to produce the maximum output. Before describing the measure, the reason why the output becomes unstable or highly noisy when a laser beam having multiple wavelengths is amplified by an SOA will be described. Hereafter, a case in which a laser beam having three wavelengths having equally spaced frequencies is amplified will be described as an example.

The frequencies of a laser beam having three wavelengths that enters an SOA are defined as [symbol] ₁, [symbol] ₂, and [symbol] ₃. In processes called degenerate four-wave mixing (degenerate FWM) and non-degenerate four-wave mixing (non-degenerate FWM), new beams having frequencies given by the following two Formulas occur.

$$\begin{matrix}[ Formula 1 ] & \\ Degenerate FWM : {v}^{′} = 2 {v}_{i} - {v}_{j} ( i , j = 1 , 2 , 3 ) & ( 1 )\end{matrix}$$

$$\begin{matrix}[ Formula 2 ] & \\ Non - degenerate FWM : {v}^{″} = 2 {v}_{i} + {v}_{j} - {v}_{k} ( i , j , k = 1 , 2 , 3 ) & ( 2 )\end{matrix}$$

FIG. 14 shows the frequency positions of an input beam to an SOA and nine FWM beams generated in the SOA. That is, six degenerate FWM beams having frequencies given by Formula (1) and 3 non-degenerate FWM beams having frequencies given by Formula (2) are generated. In FIG. 14, the input beam is shown by bold solid lines, and the FWM beams are shown by broken-line arrows.

As seen in FIG. 14, the frequencies of some of the FWM beams match those of the input beam, and interference occurs between the input beam and the FWM beams having the matching frequencies. Note that FIG. 14 illustrates a case in which [symbol] ₂ is slightly lower than the original value (the average value of [symbol] ₁ and [symbol] ₃). Thus, the positions of two beams (the input beam and an FWM beam, or FWM beams) that originally overlap each other are slightly shifted from each other so that the beams become easy to see.

If the input beam is the output of a so-called “frequency-comb light source” such as a mode-locked laser, any big problem does not occur. This is because the phase between the modes is determined and thus the phase of the FWM beams is also determined. However, if laser beams from independent three light sources 21 are used, the phase of FWM beams fluctuates randomly. This is because the phase between the laser beams is not determined. When such FWM beams interfere with an input beam amplified by an amplifier 42, a violent intensity variation (beat) occurs. The magnitude of the intensity variation is increased in proportion to the square of the intensity of the laser beams. Although the intensity variation is usually suppressed by causing the SOA to produce a low output, such a measure does not necessarily lead to acquisition of a sufficient output.

For this reason, in one aspect of the third embodiment, a transmission module 210 having a system configuration using multiple semiconductor lasers and multiple SOAs is configured under the following three rules. Thus, the transmission module 210 is able to generate stable WDM signals without being affected by FWM.
Rule 1: multiple light sources 21 (semiconductor lasers) constituting the light source unit 20 are divided into multiple groups based on the wavelength, and one or more multi-wavelength beams generated by each group are amplified by an independent SOA.
Rule 2: the wavelength positions of each group are selected such that FWM beams generated in the SOA do not overlap an input beam to the SOA.
Rule 3: modulation and multiplexing (MUX) are simultaneously performed on multi-wavelength beams from the groups using a modulator 60 having multiplexing/splitting functions.

As used herein, the term “multiplexing/splitting functions” refers to the functions of multiplexing inputted multiple multi-wavelength beams by modulating them and simultaneously removing FWM components from the beams. The groups are associated with modulation units 70 in the modulator 60. Here, the number of wavelengths that can be generated by one or more light sources 21 included in each group is defined as the element count. The element count corresponds to the number of ring modulators R of a modulation unit 70 corresponding to the group. The number of wavelengths of each of multi-wavelength beams outputted from the splitter unit 130 corresponds to the element count of a group corresponding to the multi-wavelength beam. For this reason, the number of groups is defined as n, the groups are distinguished from each other by signs G1 to Gn, and the combinations of the wavelengths in the multi-wavelength beams outputted from the splitter unit 130 are associated with the groups G1 to Gn and are also referred to as the first to n wavelength groups. The modulation units 70 corresponding to the groups G1 to Gn are referred to as the first to n-th MRM groups. Each rule will be described specifically below.

### <Rule 1>

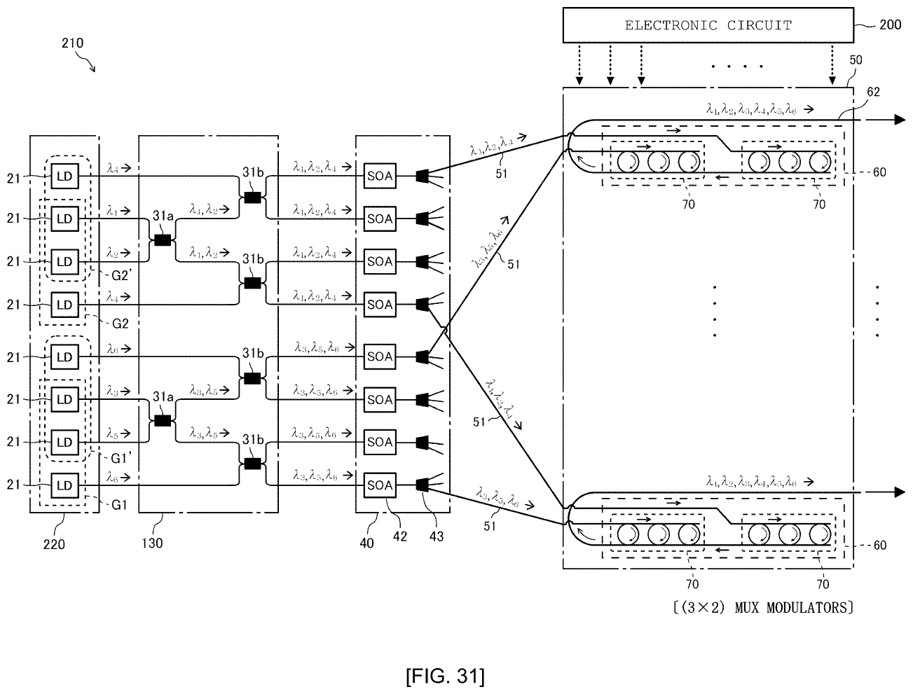

A relationship “N=m₁+m₂+ . . . +mₙ” holds, where N is the multiplexed wavelength count, n is the number of groups, mi is the element count of the i-th wavelength group (the element count of the group), and both n and mi are natural numbers. Note that if light sources 21 are shared by multiple groups, as seen in a configuration shown in FIG. 31 (to be discussed later), the number of shared light sources 21 is subtracted as an adjustment value.

### <Rule 2>

It is assumed that the frequencies of the light sources 21, which are semiconductor lasers, are placed on a WDM grid having a frequency interval f given by the following Formula. That is, the light sources 21 constituting the light source unit 120 are adjusted to oscillate a beam having a frequency νₘ satisfying Formula (3).

$$\begin{matrix}[ Formula 3 ] & \\ {λ}_{m} = {v}_{0} + m \cdot f ( m is an integer ) & ( 3 )\end{matrix}$$

In Formula (3), [symbol] ₀ is a preset reference frequency. The wavelength λₘ is obtained from the frequency [symbol] ₘ using the following Formula, where c is the speed of light.

$$\begin{matrix}[ Formula 4 ] & \\ {λ}_{m} = c / {v}_{m} & ( 4 )\end{matrix}$$

A specific example of the wavelength positions in which FWM beams do not overlap an input beam will be described below while associating the wavelength positions with the element counts of the groups.

### [When the Element Count is One]

When the element count is one, that is, when a configuration in which a single-wavelength beam enters an SOA is used, the light source 21 is allowed to have any frequency Vm on the WDM grid. This is because even when a laser beam having one wavelength (a single-wavelength beam) enters the SOA, no FWM beam is generated.

[when the Element Count is Two]

When the element count s two, that is, when a configuration in which a two-wavelength beam enters an SOA is used, each light source 21 is allowed to have any frequent Vm on the WDM grid. This is because although two beams are generated by degenerate FWM when a laser beam having two wavelengths (a two-wavelength beam) is inputted to the SOA, the frequencies of these beams do not match the frequencies of the input beam.

[when the Element Count is Three]

When the element count is three or more, that is, when a configuration in which a multi-wavelength beam having three or more wavelengths enter an SOA is used, the frequencies of FWM beams generated in the SOA are given by Formulas (1) and (2), where [symbol] ᵢ, [symbol] ⱼ, and [symbol] ₖ are the frequencies of the input beam to the SOA. For this reason, in order to obtain the wavelength positions in which FWM beams generated with the frequencies given by Formulas (1) and (2) do not overlap the input beam, a condition “when any different two sets of two wavelengths are selected from all wavelengths included in the input beam to the SOA, the two wavelengths forming one of the sets and the two wavelengths forming the other set have different frequency differences” (hereafter also referred to as the non-interference condition) has to be satisfied. The non-interference condition being that a frequency difference of two wavelengths is different in any combination of wavelengths included in a beam inputted to one of the amplifiers.

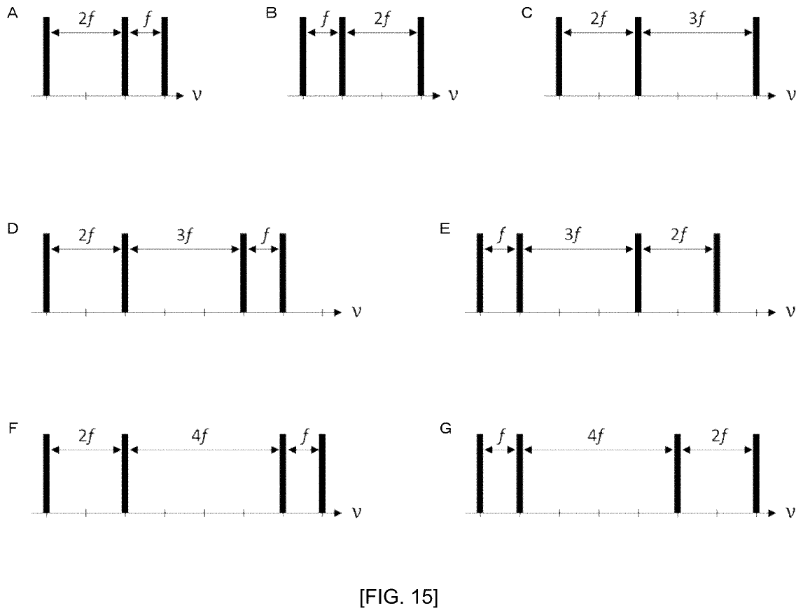

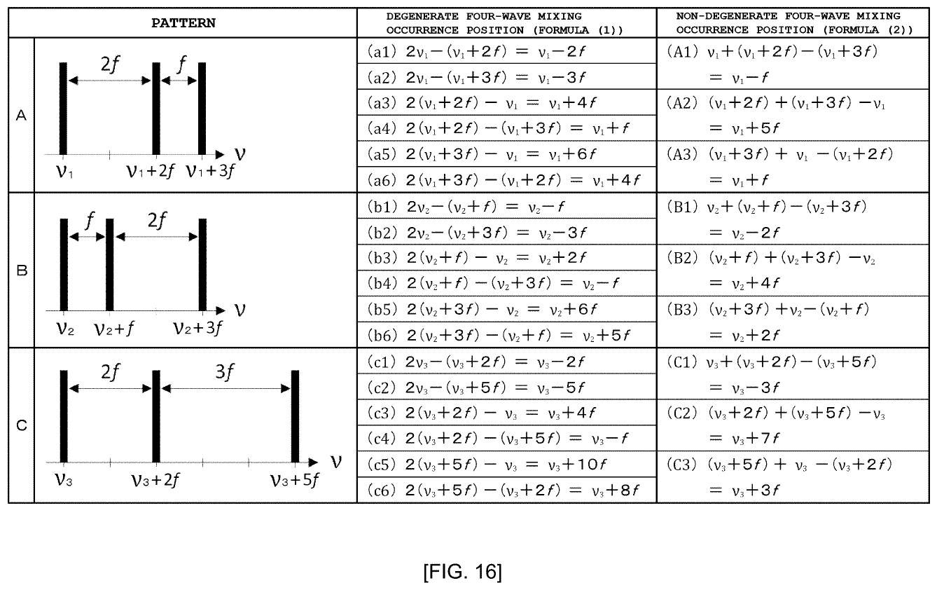

FIG. 15 schematically shows examples of wavelength positions having a narrow occupied frequency range among wavelength positions satisfying the non-interference condition. Patterns A to C correspond to multi-wavelength beams having three wavelengths (the element count is three), and patterns D to G correspond to multi-wavelength beams having four wavelengths (the element count is four). It can be confirmed in FIGS. 16 to 18 that the wavelength positions of the patterns A to G satisfy the non-interference condition.

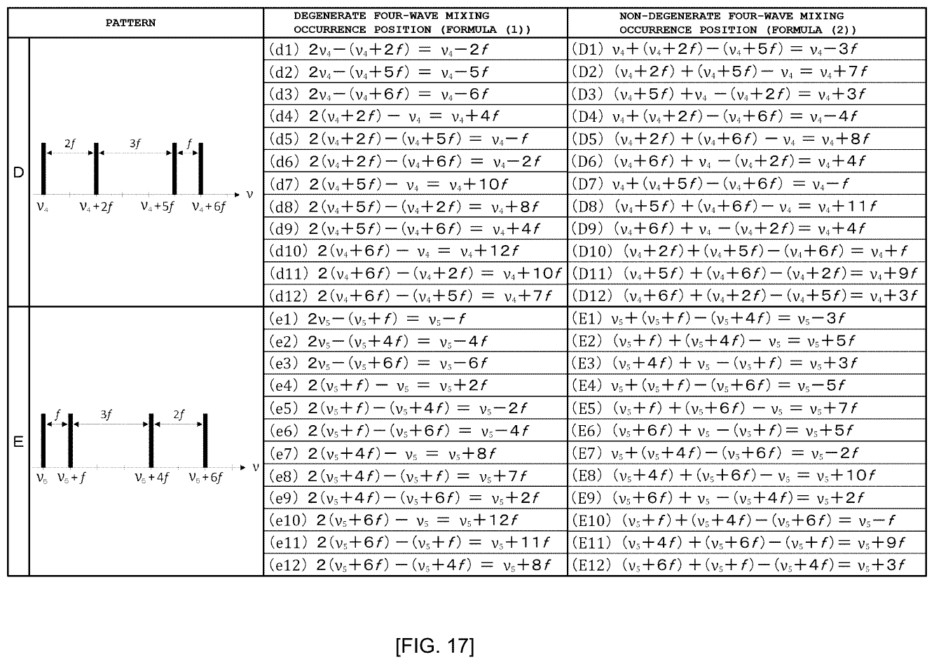

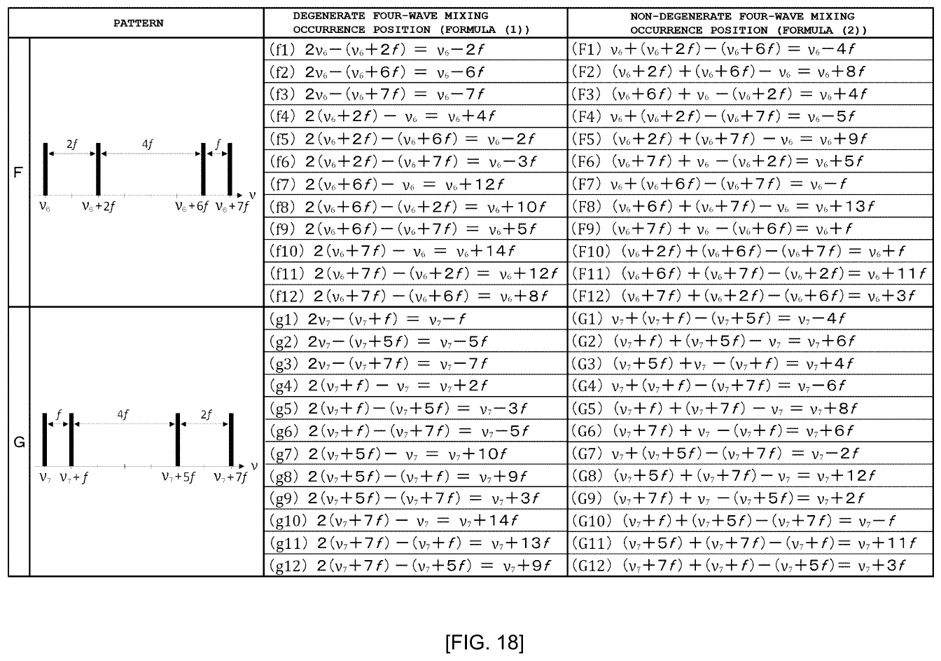

Specifically, in the patterns A to C, six FWM beams related to degenerate four-wave mixing are generated, and three FWM beams related to non-degenerate four-wave mixing are generated. However, as shown by calculations in FIG. 16, any of the frequencies of the nine FWM beams in the patterns does not match the frequencies of the input beam shown by solid lines. In the patterns D to G, 12 FWM beams related to degenerate four-wave mixing are generated, and 12 FWM beams related to non-degenerate four-wave mixing are generated. However, as shown by calculations in FIGS. 17 and 18, any of the frequencies of the 24 FWM beams in the patterns does not match the frequencies of the input beam shown by solid lines.

### <Rule 3>

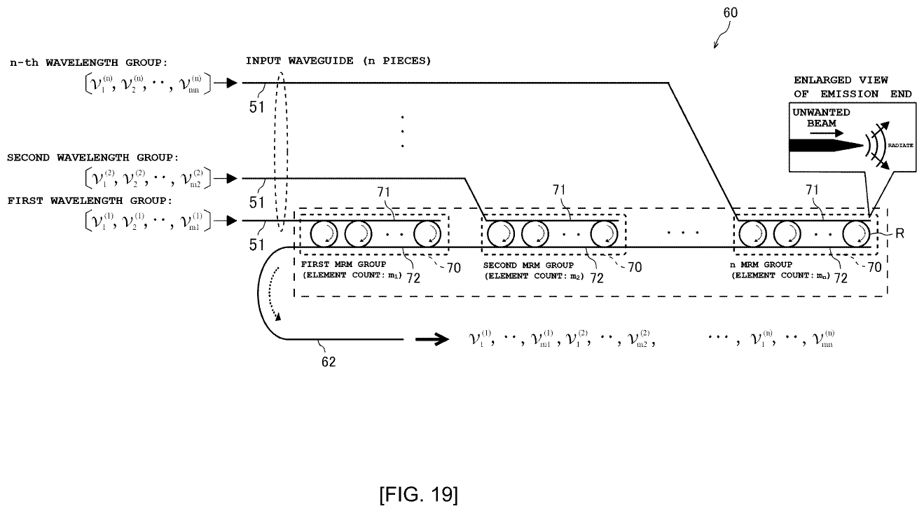

FIG. 19 shows an example configuration obtained by generalizing the modulator 60 according to the third embodiment. The modulator 60 has both a splitting function and a multiplexing function and is also referred to as the “MUX modulator”. The modulator 60 includes n modulation units 70 having a common output waveguide 62. In FIG. 19, the modulation units 70 are sequentially referred to as the first MRM group, the second MRM group, . . . , and the n-th MRM group. The i-th MRM group (i is any natural number) includes mᵢ ring modulators R. In particular, if the element counts mᵢ of the modulation units 70 (the MRM groups) of the modulator 60, that is, the numbers of the ring modulators R included in the modulation units 70 of the modulator 60 are all equal, the modulator 60 may be referred to as a (m×n) MUX modulator (m corresponds to the element count, n corresponds to the number of modulation units 70 and the number of groups).

Laser beams whose wavelengths are positioned such that FWM beams do not overlap an input beam are inputted to the input waveguides 51 of the modulation units 70 of the modulator 60, and a WDM signal is outputted from the common output waveguide 62. In principle, a laser beam of the i-th wavelength group (the element count is mᵢ) is inputted to the i-th MRM group (the element count is mᵢ) after being amplified by an SOA.

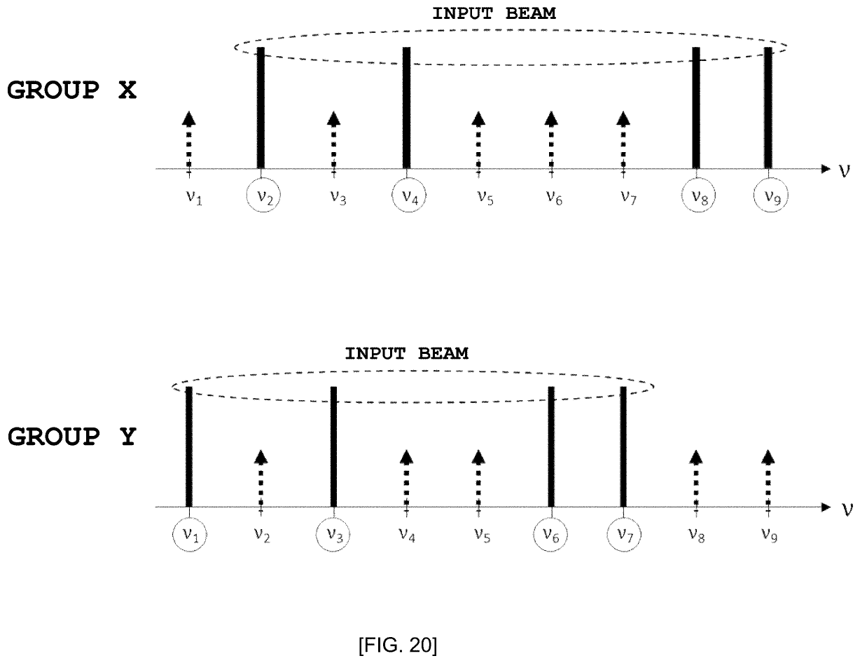

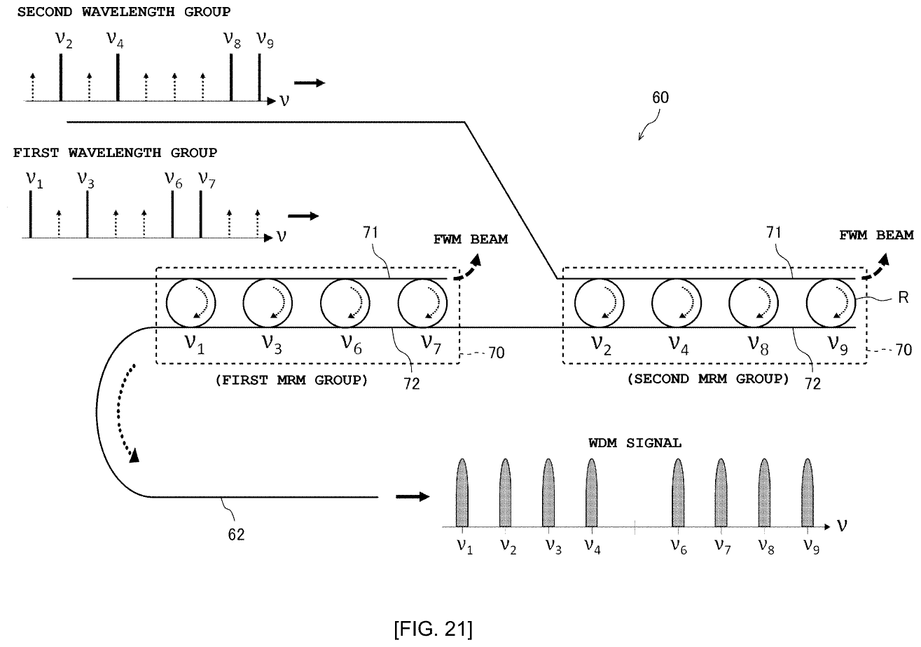

Referring to FIGS. 20 and 21, an example configuration of a modulator 60 (MUX modulator) for generating a WDM signal having eight wavelengths will be described. As shown in FIG. 20, eight wavelengths are divided into two groups, the wavelengths of a group X are set as (λ₂, λ₄, λ₈, λ₉), and the wavelengths of a group Y are set as (λ₁, λ₃, λ₆, λ₇). The group X corresponds to the pattern F in FIG. 15, and the group Y corresponds to the pattern D in FIG. 15. Note that the wavelength λₘ is determined from the frequency νₘ on the basis of Formula (4).

FIG. 20 shows output spectra when four-wavelength beams of the group X and group Y are amplified by SOAs. In FIG. 20, the mode of input beams is shown by solid lines, and the mode of FWM beams generated with frequencies determined by Formula (1) and Formula (2) is shown by broken lines. As seen in FIG. 20, while many FWM beams are generated when the beam of the group X is amplified by the SOA, no FWM beam is generated in the positions that overlap the frequencies of the input beam. This means that the four-wavelength beam of the group X is not affected by four-wave mixing when amplified by the SOA. That is, the SOA can acquire a stable output. Similarly, when the four-wavelength beam of the group Y is amplified by an SOA, no FWM beam is generated in the positions that overlap the frequencies of the input beam. That is, the SOA can acquire a stable output.

However, when the SOA output of the group X and the SOA output of the group Y are multiplexed using an ordinary method, an unstable output will be produced. This is because some of the FWM beams included in the SOA output of the group X interfere with the main beam of the group Y and some of the FWM beams included in the SOA output of the group Y interfere with the main beam of the group X, leading to occurrence of a beat. That is, it is not appropriate to multiplex the SOA output of the group X and the SOA output of the group Y using a coupler or the like.

For this reason, in the example configuration in FIG. 21, the two four-wavelength beams amplified by the SOAs are guided to a (4×2) MUX modulator and modulated and multiplexed there. As shown in FIG. 21, the (4×2) MUX modulator consists of two four-element modulation units 70 (MRM groups) sharing an output waveguide 62. Four ring modulators R constituting the first MRM group have resonance frequencies tuned with the frequencies of the laser beam of the group X. The SOA output of the group X is guided to the sorting waveguide 71 of the first MRM group, modulated by the ring modulators R thereof, and outputted from the output waveguide 62 as an optical signal.

Although many FWM beams are included in the output of the SOA, the frequencies thereof do not match the resonance frequency of any ring modulator R. For this reason, the FWM beams are released from the output end of the sorting waveguide 71. Similarly, the laser beams of the group Y outputted from the SOA are guided to the sorting waveguide 71 of the second MRM group, modulated by the ring modulators R thereof, and outputted from the output waveguide 62 as an optical signal. In the output waveguide 62, the optical signal of the group X and the optical signal of the group Y co-exist. A WDM signal having eight wavelengths, which is in a form in which the central one wavelength (λ₅) is removed from the continuous nine wavelengths (λ₁ to λ₉), is outputted from the output waveguide 62. As seen above, the MUX modulator has both the function of modulating and multiplexing the inputted multiple multi-wavelength beams and the function of removing the unnecessary FWM components.

Preferably, the emission ends of the input waveguides 51 (the sorting waveguides 71) are configured to have low reflectance in order to avoid oscillation of any SOA due to a return beam from the MUX modulator. For that purpose, as shown in an inserted diagram (an enlarged view of the emission end) of FIG. 19, it is preferred to change the structure of the emission end so that the efficiency of conversion from the eigenmode to the radiation mode is increased, as described above with reference to FIG. 3. Also, a diffraction grating may be formed on the emission end of each input waveguide 51 or a light absorbing material may be disposed thereon so that oscillation of any amplifier 42 due to a return beam from the modulator 60 is suppressed.

Assuming that [symbol] ₀=228. 2 THz and Δ [symbol] =800 GHz in Formulas (3) and (4), a WDM signal having the following eight wavelengths can be generated by the (4×2) MUX modulator shown in FIG. 21.

$${λ}_{1} = 13 9.14 nm ( 229. THz )$$

$${λ}_{2} = 1304.58 nm ( 229.8 THz )$$

$${λ}_{3} = 13 0.05 nm ( 230. 60 THz )$$

$${λ}_{4} = 12 95.56 nm ( 231.4 THz )$$

$${λ}_{6} = 12 86.66 nm ( 233. THz )$$

$${λ}_{7} = 1282.26 nm ( 233.8 THz )$$

$${λ}_{8} = 12 77.89 nm ( 224.6 THz )$$

$${λ}_{9} = 1273.55 nm ( 225.4 THz )$$

These wavelength positions comply with the IEEE 802.3bs standard (400 GbE-LR8) related to 1.3 um-band optical communication.

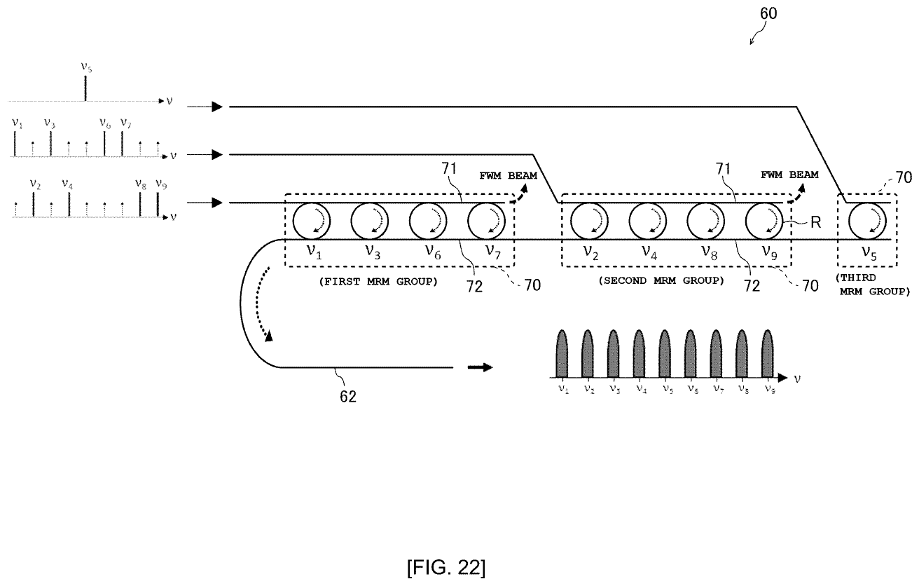

When there is a need to generate a WDM signal having continuous nine wavelengths (λ₁ to λ₉), it is preferred to use an MUX modulator having a configuration shown in FIG. 22. In the case of this configuration, n=3 and (m₁, m₂, m₃)=(4, 4, 1). In FIG. 22, the third MRM group whose element count is one is used as one modulation unit 70. For example, the third MRM group may apply intensity modulation of the clock frequency to a beam (wavelength: λ₅) that enters this MRM group. Thus, the third MRM group can be used so as to add an optical clock to an eight-wavelength WDM signal and transmit the resulting signal. Note that one of the ring modulators R of each modulation unit 70 of a modulator 60 as shown in FIG. 21 may be used as a ring modulator R for adding a clock signal.

According to the notation of the third embodiment, the modulator 60 in FIG. is expressed as a (1×8) MUX modulator, and the modulator 60 in FIG. 12 is expressed as a (2×4) MUX modulator. As described above, these modulators are also able to generate a WDM signal having continuous eight wavelengths (λ₁ to λ₈). Each modulator 60 may consist of only modulation units 70 whose element counts are equal, may consist of modulation units 70 whose element counts are equal and modulation units 70 whose element counts are different from those of the former modulation units 70, or may consist of modulation units 70 whose element counts are different from each other.

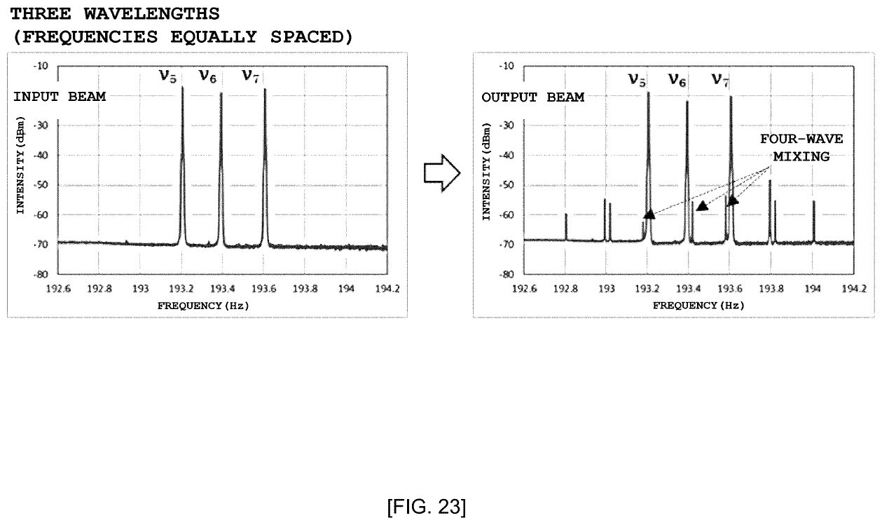

Next, referring to FIGS. 23 to 26, the results of a demonstration experiment of the modulator 60, modulation system 50, and transmission module 210 according to the third embodiment will be described. In this demonstration experiment, multi-wavelength beams were amplified using SOAs (output=14 dBm) of the C band in optical communication, and outputs having different wavelength positions were compared. FIGS. 23 to 25 are graphs showing the spectra of measured input/output beams. The laser frequencies ν₀ and Δν were set to 192.2 THz and 200 GHz, respectively, on the basis of Formula (3). Note that to avoid an FWM beam being hidden behind the input beam and disappearing, one of the frequencies of the laser beam was slightly shifted from the original value.

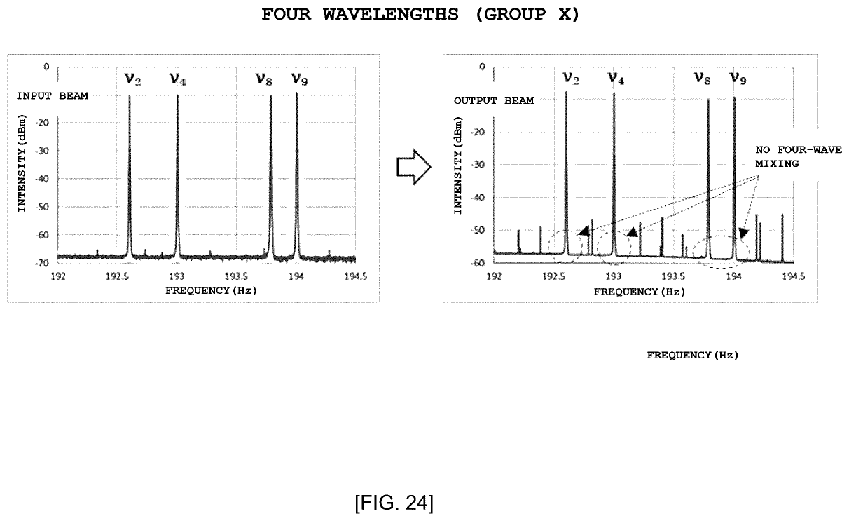

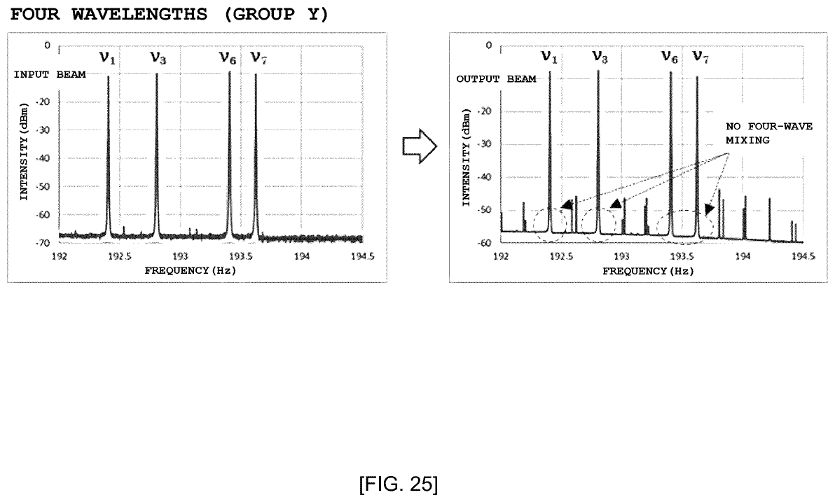

FIG. 23 shows the results when a laser beam having three wavelengths having equally spaced frequencies is amplified. An output spectrum in FIG. 23 indicates that FWM beams were generated near the input beam. FIGS. 24 and 25 are graphs corresponding to FIG. 20 and each show the results when a four-wavelength laser beam having the wavelength positions of the group X or group Y was amplified. While the output includes many four-wave mixing beams in either case, it can be confirmed that no FWM beam was generated near the input beam (within circular broken lines).

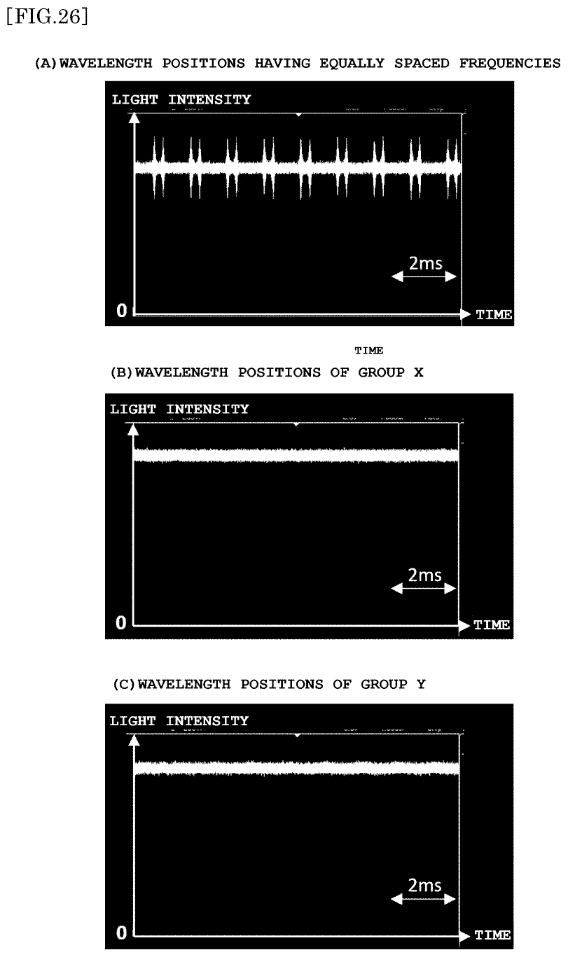

FIGS. 26A to 26C are diagrams showing changes over time in the intensity of an output beam when the three-wavelength or four-wavelength laser beam was amplified by an SOA. FIG. 26A shows the measurement results of the three-wavelength laser beam having equally spaced frequencies and corresponds to FIG. 23. FIG. 26A shows that the intensity varied by 10% or more. Note that some sections in which the intensity did not vary at all are seen in the output wavelength in FIG. 26A. This is because the bandwidth of the detector was insufficient. FIG. 26B shows the measurement results of the output beam having the wavelength positions of the group X, and FIG. 26C shows the measurement results of the output beam having the wavelength positions of the group Y. It can be understood that both the beam having the wavelength positions of the group X and the beam having the wavelength positions of the group Y were stable outputs.

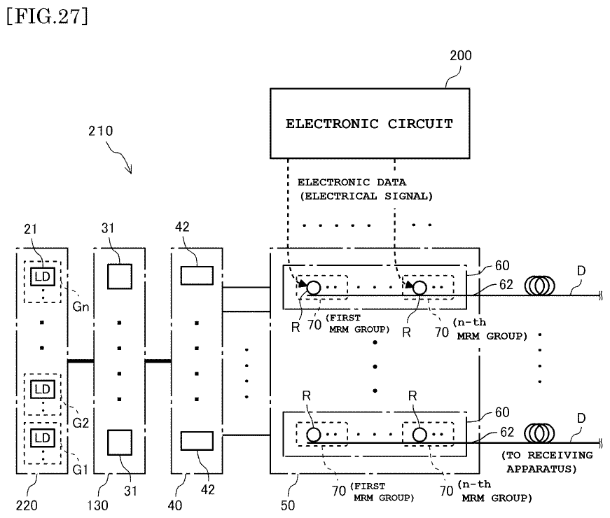

Next, referring to FIGS. 27 to 31, a specific example of the transmission module 210 having a configuration for preventing interference caused by occurrence of FWM beams will be described. First, referring to FIG. 27, the overall configuration of the transmission module 210 according to one aspect of the third embodiment and peripheral devices thereof will be described.

As shown in FIG. 27, the transmission module 210 includes a light source unit 220 including multiple light sources 21, a splitter unit 130 including multiple splitters 31, an amplification unit 40 including multiple amplifiers 42, and a modulation system 50 including multiple modulators 60. The light source unit 220 includes the light sources 21 that emit beams having different wavelengths, and the light sources 21 are divided into groups of one or more light sources 21 in accordance with the preset element counts and the light source count M.

In the splitter unit 130, the splitters 31 consisting of (2×2) splitters are cascade-connected. In the modulation 50, multiple system modulation units 70 constituting each modulator 60 each include the same number of ring modulators R as the element count (the light source count M) of a corresponding group. The notation of groups G1 to Gn in FIG. 27 is for convenience's sake and does not mean that the number of groups of light sources 21 is three or more. The number of groups of light sources 21 may be two. Also, the number of light sources 21 constituting each group may be one, two, or three or more. In short, it is only necessary to provide a configuration for preventing interference caused by occurrence of FWM beams on each route along which a multi-wavelength beam having three or more wavelengths is amplified by an SOA.

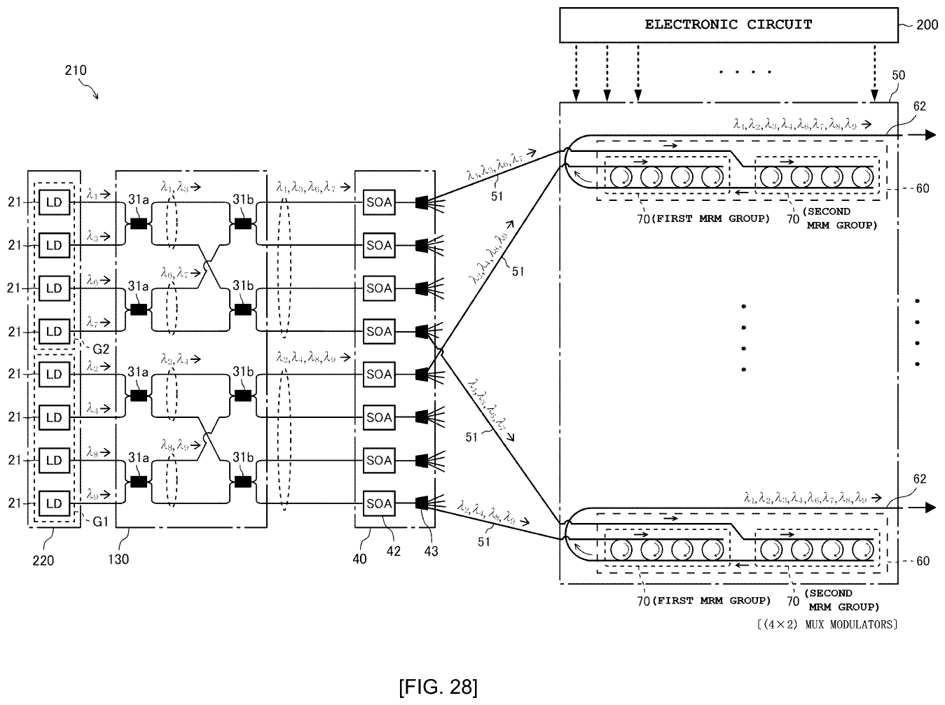

Next, referring to FIG. 28, an example of a transmission module 210 in which four-wavelength beams are amplified by SOAs will be described. The transmission module 210 in FIG. 28 corresponds to the configuration shown in FIG. 21, a light source unit 220 includes two groups each consisting of four light sources 21, and modulation units 70 constituting each modulator 60 each include four ring modulators R. A group G1 and a group G2 correspond to the group X and group Y, respectively, in FIG. 20. Of the splitters 31 of the splitter unit 130 in FIG. 28, splitters 31 in the first stage of the two-stage cascade are referred to as the splitters 31a, and splitters 31 in the second stage as the splitters 31b.

Specifically, the wavelengths of the light sources 21 of the group G1 are set to λ₂, λ₄, λ₈, and λ₉, and the wavelengths of the light sources 21 of the group G2 are set to λ₁, λ₃, λ₆, and λ₇. Outputs from the light sources 21 of the groups are combined and split by the splitter unit 130 consisting of (2×2) splitters 31 cascaded in two stages, amplified by the amplifiers 42, and then split into multiple paths by sorters 43 consisting of (1×r) splitters. An output from each amplifier 42 related to the group G1 and an output from each amplifier 42 related to the group G2 are guided to a modulator 60, which is a (4×2) MUX modulator, and multiplexed and modulated there. Then, 4r eight-wavelength WDM signals compliant with the IEEE 802.3bs standard (400 GbE-LR8) are outputted from the modulation system 50. Note that each group only has to have wavelength positions satisfying the non-interference and the configuration in FIG. 28 is not limiting.

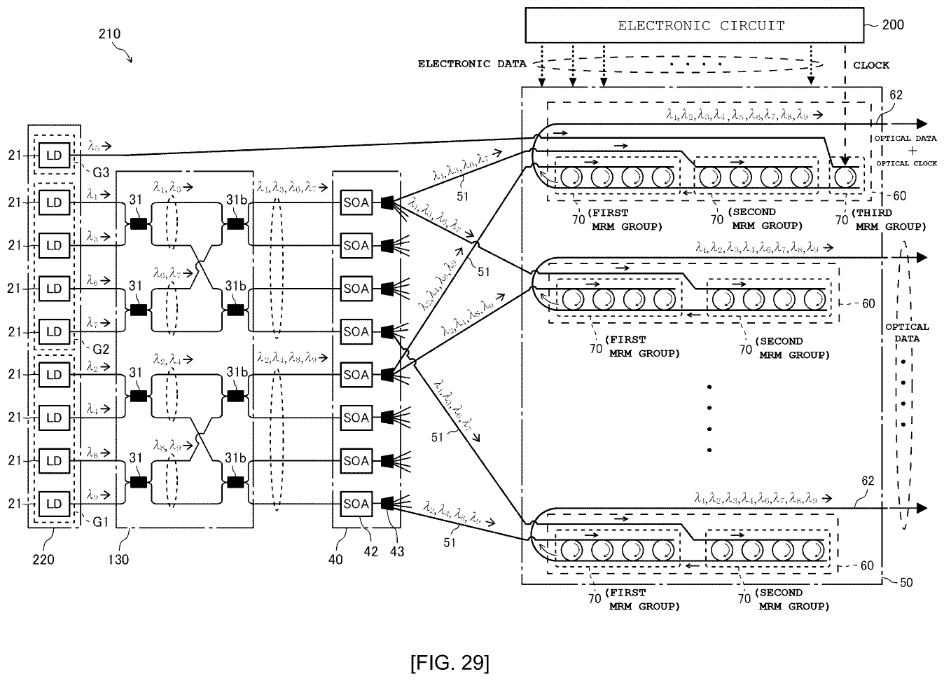

Next, referring to FIG. 29, another example of the transmission module 210 in which four-wavelength beams are amplified by SOAs will be described. FIG. 29 shows an example configuration of a co-package having an optical clock transmission function. Specifically, the transmission module 210 in FIG. 29 is a transmission module obtained by adding one light source 21 (wavelength: λ₅) to the configuration shown in FIG. 28 and changing one of 4r (4×2) MUX modulators to the MUX modulator for nine wavelengths shown in FIG. 22.

The transmission module 210 in FIG. 29 is configured such that the third 3MRM group adds an optical clock (wavelength: λ₅) to an eight-wavelength WDM signal by applying a clock signal rather than data to the ring modulator R thereof. The receiving side is able to reproduce the clock by only cutting out the optical clock using a filter and converting it into an electrical signal.

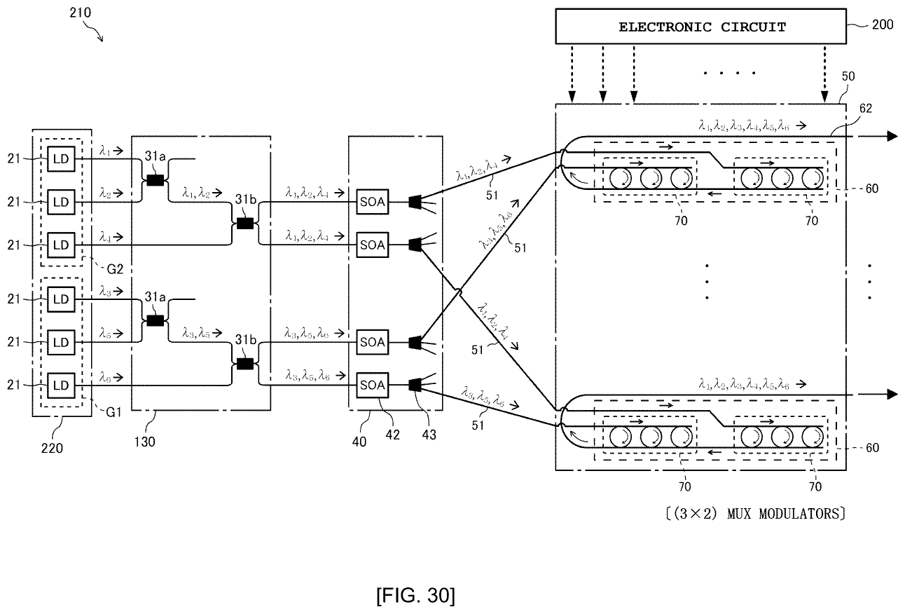

Next, referring to FIG. 30, an example of a transmission module 210 in which three-wavelength beams are amplified by SOAs will be described. In the transmission module 210 in FIG. 30, a light source unit 220 includes two groups each consisting of three light sources 21, and modulation units 70 constituting each modulator 60 each include three ring modulators R. A group G1 has wavelength positions corresponding to the pattern B in FIG. 15, and a group G2 has wavelength positions corresponding to the pattern A in FIG. 15. Each group only has to have wavelength positions satisfying the non-interference and the configuration in FIG. 30 is not limiting. Of the splitters 31 of a splitter unit 130 in FIG. 30, splitters 31 in the first stage of the two-stage cascade are referred to as the splitters 31a, and splitters 31 in the second stage as the splitters 31b.

Next, referring to FIG. 31, another example of the transmission module 210 in which three-wavelength beams are amplified by SOAs will be described. In the transmission module 210 in FIG. 31, a light source unit 220 includes four groups each consisting of three light sources 21, and modulation units 70 constituting each modulator 60 each include three ring modulators R. A group G1 and a group G1′ share two light sources 21. Similarly, a group G2 and a group G2′ share two light sources 21.

In the case of groups consisting of three light sources 21, the number of groups can be doubled by adding one light source 21 as shown in FIG. 31 to each of groups as shown in FIG. 30, and the number of three-wavelength beams outputted from the splitter unit 130 can be doubled by using the outputs of the splitters 31a and adding splitters 31b.

The example configurations shown in FIGS. 28 to 31 can be summarized as follows.

That is, the transmission module 210 includes the light sources 21 divided into groups including a group of three or more light sources 21 so that the wavelengths of beams emitted from the light sources 21 do not overlap each other, the splitter unit 130 including the cascaded splitters 31 associated with the groups, the amplifiers 42 connected to the splitters 31 disposed in the latter stage of the splitter unit 130, the sorters 43 connected to the amplifiers 42, and the modulation system 50 including the modulators 60 connected to the sorters 43 corresponding to the different groups. The modulators 60 each include the modulation units 70 each including the three or more ring modulators R, as well as each include the output waveguide 62 that multiplexes beams that have passed through the ring modulators R and outputs a multiplexed beam. Each modulation unit 70 includes the sorting waveguide 71 that guides a beam inputted from outside to the multiple ring modulator R. The ring modulators R in each modulator 60 have resonance frequencies adjusted to differ from each other. Beams emitted from the three or more light sources 21 forming the above group have wavelengths set such that the non-interference condition that when any different two sets of two wavelengths are selected from all wavelengths included in a beam inputted to one of the amplifiers 42, the two wavelengths forming one of the two sets and the two wavelengths forming the other set have different frequency differences is satisfied. The transmission module 210 may be configured not to include the light sources 21. In this case, the resonance frequencies of the three or more ring modulators R of each modulation unit 70 are adjusted to correspond to three or more different wavelengths set to avoid interference caused by four-wave mixing when a multi-wavelength beam having three or more wavelengths is amplified. That is, the resonance frequencies of the three or more ring modulators R are adjusted so that when any two different sets of two wavelengths are selected from the wavelengths corresponding to the resonance frequencies, the two wavelengths forming one of the two sets and the two wavelengths forming the other set have different frequency differences. In other words, the resonance frequencies of the three or more ring modulators R are adjusted so that when any two different sets of two adjacent wavelengths are selected from the wavelengths corresponding to the resonance frequencies, the two adjacent wavelengths forming one of the two sets and the two adjacent wavelengths forming the other set have different frequency differences. In short, the three or more ring modulators have the resonance frequencies adjusted so that a frequency difference of two wavelengths is different in any combination of the wavelengths corresponding to the resonance frequencies.

As described above, the modulator 60 according to the third embodiment includes the modulation units 70 each including the one or more ring modulators R, as well as each include the output waveguide 62 that multiplexes beams that have passed through the ring modulators R and outputs a multiplexed beam. Each modulation unit 70 includes the sorting waveguide 71 that guides a beam inputted from outside to the ring modulator(s) R. The ring modulator(s) R have resonance frequencies adjusted to differ from each other. Thus, the modulator 60 is able to generate a desired multi-wavelength beam from inputted multiple beams and to output it. By using the modulators 60 thus configured in combination, the data communication capacity can be increased without having to increase the number of light sources.

The modulator 60 is configured such that at least one of the modulation units 70 includes the three or more ring modulators R having the resonance frequencies adjusted to correspond to the three or more different wavelengths set to avoid interference caused by four-wave mixing when a multi-wavelength beam having three or more wavelengths is amplified. That is, the modulator 60 includes the modulation unit 70 including the three or more ring modulators R having the resonance frequencies adjusted in accordance with the wavelength positions satisfying the non-interference condition. Thus, the modulator 60 is able to multiplex multi-wavelength beams having wavelength positions satisfying the non-interference condition inputted through the amplifiers 42 by performing significant modulation on the beams and to simultaneously remove FWM components from the beams. By using the modulation system 50 including the modulators 60 along with the amplifiers 42, the data communication capacity can be increased without having to increase the number of light sources 21.

The largest merit of use of an MUX modulator is to allow SOAs to produce a high output when each SOA amplifies a multi-wavelength beam. Thie merit is extremely important not only to an internal light source-type co-package, but also to an external light source-type co-package. In one modulator 60, at least one of the modulation units 70 may include a ring modulator R for adding a clock signal. Thus, the modulation system 50 is able to transmit a WDM signal having an optical clock added thereto and thus to increase convenience. Other advantageous effects and the like are similar to those of the above embodiments.

The transmission module 210 may consist of the amplifiers 42 and the modulation system 50, or may consist of these and the splitter unit 130. The transmission module 210 may further include the light sources 21. In this case, the light sources 21 may be divided into multiple groups including a group of three or more light sources 21, and the wavelengths of beams emitted from the three or more light sources 21 forming the group may be set such that the non-interference condition that when any two different sets of two wavelengths are selected from all wavelengths included in a beam inputted to one of the amplifiers 42, the two wavelengths forming one of the two sets and the two wavelengths forming the other set have different frequency differences is satisfied.

The configuration of the modification 1B may be applied to the configuration of the third embodiment. That is, the configuration of the third embodiment may use the light source systems 121 each including the main light source (the light source 21a) and the backup light source (the light source 21b) in place of the light sources 21 to make the light sources redundant. Also, the configuration of the modification 1A may be applied to the configuration of the third embodiment.

### Fourth Embodiment

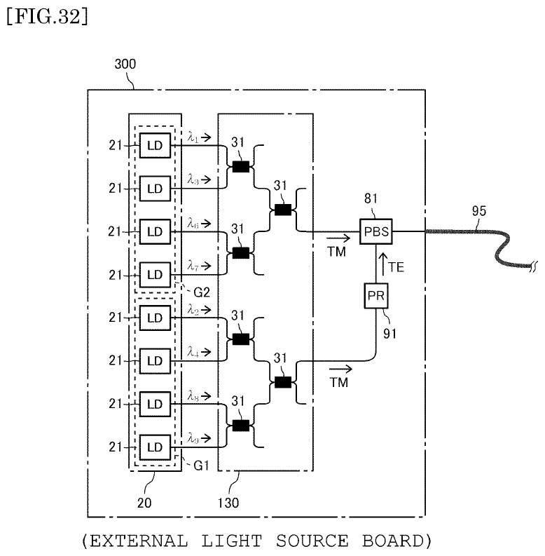

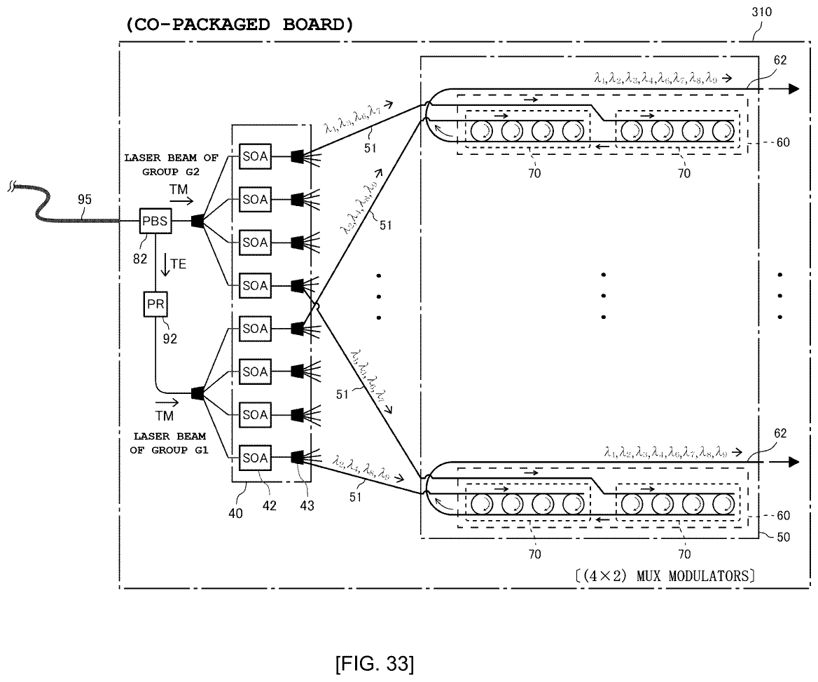

Referring to FIGS. 32 and 33, an example configuration of a transmission module according to a fourth embodiment of the present invention will be described. FIGS. 32 and 33 show example configurations when an MUX modulator is applied to an external light source-type co-package.

An external light source board 300 has thereon eight light sources 21 that output TM polarized beams. The light sources 21 are divided into two groups (G1 and G2) on the basis of the wavelengths of laser beams to be emitted from them. The wavelength positions of each group is set to satisfy the non-interference condition. In FIG. 32, the groups have the same wavelength positions as those in an example in FIG. 28 (group G1: λ₂, λ₄, λ₈, λ₉, group G2: λ₁, λ₃, λ₆, λ₇).

On the external light source board 300, laser beams outputted from the groups are combined by multiple splitters 31 disposed in two stages. The output of the group G1 is converted into a TE beam by a polarization rotator (PR) 91, then multiplexed with the output of the group G2 by a polarized beam splitter (PBS) 81, and guided to a PM fiber 95.

The slow-axis and fast-axis of the PM fiber 95 are matched with the polarization direction of the TE beam and the polarization direction of the TM beam, respectively, in the waveguide. The laser beam of the group G1 and group G2 guided to a co-packaged board 310 by the PM fiber 95 is split by a polarized beam splitter 82. The polarized light of the group G1 is converted back from the TE beam to the TM beam by a polarization rotator 92. The split laser beams of the group G1 and group G2 are each split into four beams and amplified by amplifiers 42. The outputs of the amplifiers 42 are each divided into four beams and guided to (4×2) MUX modulators (modulators 60) and modulated and multiplexed there.

In the case of a combination method using (2×2) splitters as shown in FIG. 32, only ¼ of the entire laser output is used, and a loss of 6 dB occurs. However, this loss attenuates the intensity of a return beam from the end face of the fiber to ¼ and therefore produces an advantageous effect equivalent to that of insertion of an isolator (isolation=12 dB). The loss made by the splitters is allowable in terms of this advantageous effect. The splitter unit consisting of the (2×2) splitters may be replaced with an arrayed waveguide grating (AWG).

The modulator 60 according to the fourth embodiment has a configuration similar to those according to the above embodiments and therefore is able to generate a desired multi-wavelength beam from inputted multiple beams and to output it. By using the modulators 60 thus configured in combination as shown in FIG. 33, the data communication capacity can be increased without having to increase the number of light sources. The transmission module according to the fourth embodiment is of the external light source-type, and, as with the example configurations of the embodiments, the co-packaged board 310 is able to generate significant WDM signals from multi-wavelength signals transmitted from the external light sources and to output them. Note that the transmission module does not have to include the external light source board 300. In this case, the co-packaged board 310 serves as the transmission module according to the fourth embodiment.

The configuration of the modification 1B may be applied to the configuration of the fourth embodiment. That is, the configuration of the fourth embodiment may use the light source systems 121 each including the main light source (the light source 21a) and the backup light source (the light source 21b) in place of the light sources 21 to make the light sources redundant. Also, the configuration of the modification 1A may be applied to the configuration of the fourth embodiment.

### <Modification 4A>

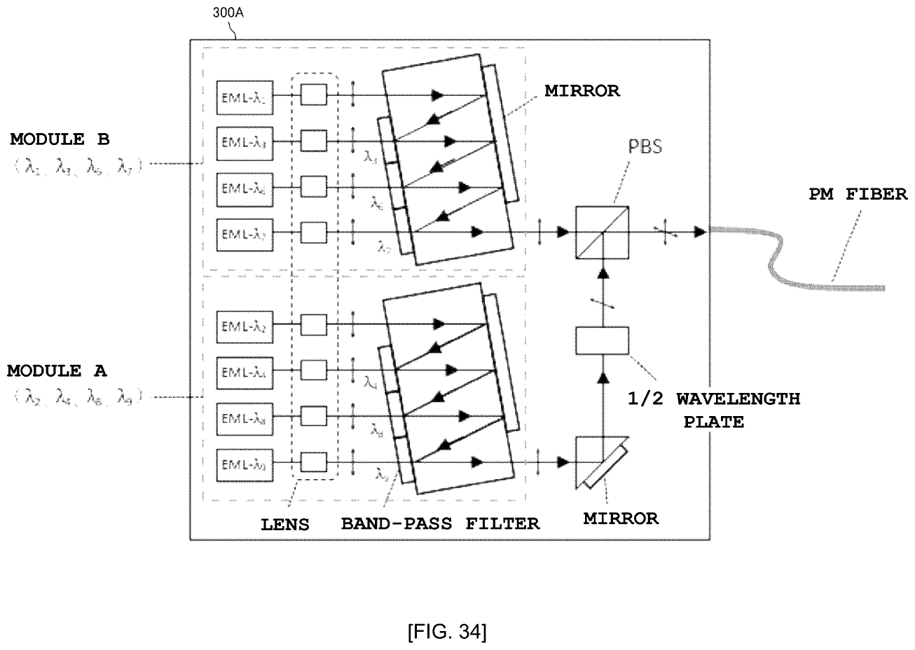

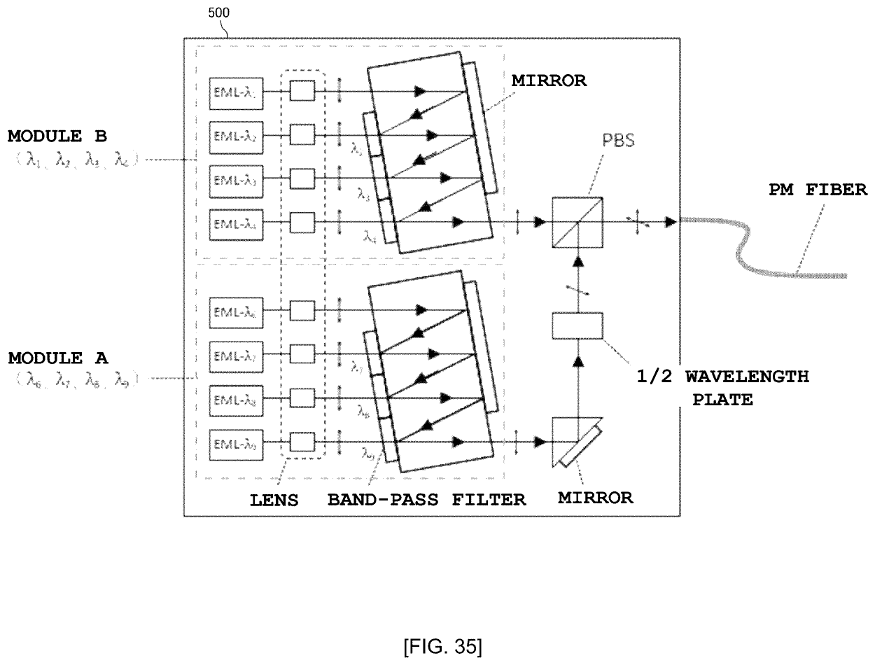

Referring to FIGS. 34 and 35, an example configuration according to a modification 4A of the fourth embodiment of the present invention will be described. One of the components of a small optical transceiver is a transmitter optical sub-assembly (TOSA) for generating four or eight-wavelength WDM signals. The external light source board 200 in FIG. 32 can be replaced with a TOSA, which does not superimpose data on an optical signal, that is, operates without modulation.

First, a typical conventional configuration of a 8ch-TOSA shown in FIG. 35 will be described. An external light source board 500 consists of two 4ch-WDM modules (A, B). The polarization of the output of the module A is rotated by 90° using a ½ wavelength plate, and the resulting output is multiplexed with the output of the module B by a PBS. The two WDM modules each have four electro-absorption modulator lasers (EMLs) thereon, and the outputs thereof are combined using mirrors and WDM filters (bandpass filers). The wavelengths of the EMLs and corresponding WDM filters comply with the IEEE 802.3bs standard (400 GbE-LR8). The wavelengths of those on the module A are set to fourth wavelengths (λ₆, λ₇, λ₈, λ₉) on the high frequency side, and the wavelengths of those on the module B are set to four wavelengths (λ₁, λ₂, λ₃, λ₄) on the low frequency side. However, as described above, these wavelength positions are not suitable for amplification using SOAs.

Next, referring to FIG. 34, an external light source board 300A according to the modification 4A will be described. As shown in FIG. 34, the positions of four wavelengths of a module A on the external light source board 300A are “λ₂, λ₄, λ₈, λ₉”, and the positions of four wavelengths of a module B thereon are “λ₁, λ₃, λ₆, λ₇”. Any of these wavelength positions satisfies the non-interference condition. That is, by changing the wavelength positions of each group consisting of the EMLs such that the wavelength positions satisfy the non-interference condition, multi-wavelength beams having three or more wavelengths can be favorably amplified by amplifiers 42 consisting of SOAs without being degraded by FWM.

As described above, in introducing laser beams from external light sources to a co-packaged board, the conventional configuration or method is not suitable for amplification using SOAs. For this reason, many expensive PM fibers corresponding to the number of lasers have to be used. In contrast, on the external light source board 300A according to the modification 4A, the light source groups mounted on the multiple modules have the wavelength positions satisfying the non-interference condition. Thus, even when multi-wavelength beams multiplexed on the external light source board 200A are amplified by the amplifiers 42 of the co-packaged board 310 illustrated in FIG. 33, interference caused by occurrence of FWM beams can be prevented. Thus, MUX modulators are able to generate many stable WDM signals from the multi-wavelength beams guided by the single PM fiber. Also, in the case of the configuration according to the modification 4A, a TOSA becoming popular as a component of a transceiver can be used as light sources. That is, use of the MUX modulators can increase the reliability of the external light source-type co-package and reduce the price.

The modulators, modulation systems, and transmission modules according to the above embodiments are only illustrative, and the technical scope of the present invention is not limited to these aspects. For example, a selection or change may be made as to which of the components of the transmission module according to each embodiment should be included in a co-package, as needed. Also, the combination of the modulators 60 in the modulation system 50 may be selected or changed as needed. While optical fiber amplifiers (OFAs) such as erbium-doped fiber amplifiers (EDFAs) may be used as the amplifiers 42, semiconductor optical amplifiers (SOAs) are more suitable for downsizing and integration.

While the above embodiments have been described assuming that the light sources 21 are semiconductor lasers (LDs), this assumption is not limiting. Research on multi-wavelength lasers has progressed in recent years, and among others, hybrid lasers using silicon phonics are attracting attention as light sources for co-packaging. With respect to hybrid lasers reported thus far, the oscillation wavelengths are equally spaced, and the phases of the oscillation modes are not synchronized. For this reason, it is predicted that the output of such a hybrid laser will be made unstable by FWM when amplified by an SOA. However, even when such a hybrid laser is used, the output thereof can be stably amplified as long as the output has wavelength positions satisfying the non-interference condition (λ₂, λ₄, λ₈, λ₉ of the group G1 and λ₁, λ₃, λ₆, λ₇ of the group G2 in FIG. 28), as shown in the examples in FIG. 28 and the like. Thus, a stable WDM signal can be generated from the SOA output using an MUX modulator. For this reason, particularly, in the transmission modules according to the third and fourth embodiments, the light source unit 220 may be configured to include hybrid lasers having wavelength positions satisfying the non-interference condition in place of the light sources 21 constituting the groups.

In converting electrical signals of data into optical signals, external modulators may be used instead of directly modulating beams from LDs. In this case, the number of LDs to be provided does not have to be the number of all the channels but rather only has to be the multiplexed wavelength count. While an SOA is an optical semiconductor component as is an LD, its failure rate is much lower than the LD due to it not being an oscillator. The LD is required to oscillate always in a single mode, and its wavelength is required to comply with the WDM grid. When the suppression ratio of the adjacent mode is only reduced or when the wavelength is only shifted from the WDM grid, the system would no longer operate properly. On the other hand, the SOA is a simple amplifier. For this reason, even when the output of the SOA slightly varies, such a variation would not affect the operation of the system. The SOA is also able to produce a higher output than the LD. While an SOA having a quantum well structure is typical, an SOA having a quantum dot structure can be expected to exhibit more excellent characteristics when operating at high temperature and high output. The merits of introduction of SOAs to a system include low-output operation of LDs and a significant reduction in the rate of failures caused by catastrophic optical damage (COD). It is estimated that when the output from the end face of an LD is reduced to ¼, the probability of COD will be reduced to 1/10 or less. Moreover, a dramatic reduction in the number of LDs will lead to a reduction in the power consumption of the system.

### LIST OF REFERENCE SIGNS

10, 110, 210 transmission module, 20, 120, 220 light source unit 20, 21, 21a, 21b light source, 22 selection unit, 22 intensity modulator, 23a first waveguide, 23b second waveguide, 24 switching unit, 25 monitoring unit, 26 redundant processing unit, 30, 130 splitter unit, 31, 31a, 31b, 31c, splitter, 43 sorter, 40, 140 amplification unit, 41 amplification unit, 42 amplifier, 50, 50A, 50B modulation system, 51 input waveguide, 60 modulator, 62 output waveguide, 70 modulation unit, 71 sorting waveguide, 72 resonance waveguide, 81, 82 polarized beam splitter, 91, 92 polarization rotator, 95 PM fiber, 121 light source system, 200 electronic circuit, 300, 300A external light source board, 310 co-packaged board.

1-11. (canceled)

12. A modulator comprising:
a plurality of modulation units each comprising a plurality of ring modulators; and
an output waveguide configured to multiplex beams that have passed through the ring modulators included in the modulation units and output a multiplexed beam,
wherein the modulation units each comprise a sorting waveguide configured to guide a beam inputted from outside to the ring modulators, and
wherein all the ring modulators included in the modulation units have resonance frequencies adjusted to differ from each other.

13. A modulator comprising:
a plurality of modulation units each comprising one or more ring modulators; and
an output waveguide configured to multiplex beams that have passed through the ring modulators included in the modulation units and output a multiplexed beam,
wherein the modulation units each comprise a sorting waveguide configured to guide a beam inputted from outside to the one or more ring modulators,
wherein all the ring modulators included in the modulation units have resonance frequencies adjusted to differ from each other,
wherein at least one of the modulation units comprises the three or more ring modulators having the resonance frequencies adjusted to correspond to three or more different wavelengths, and
wherein the three or more ring modulators have the resonance frequencies adjusted so that when any two different sets of two wavelengths are selected from the wavelengths corresponding to the resonance frequencies, the two wavelengths forming one of the two sets and the two wavelengths forming the other set have different frequency differences.

14. The modulator of claim 12, wherein the ring modulators of at least one of the modulation units include a ring modulator for adding a clock signal.

15. The modulator of claim 14, wherein the one or more ring modulators of one of the modulation units include a ring modulator for adding a clock signal.

16. A modulation system comprising the plurality of modulators of claim 12.

17. A transmission module comprising:
a plurality of amplifiers directly or indirectly connected to a plurality of light sources and each configured to amplify an inputted beam; and
the modulation system of claim 16 disposed in a subsequent stage of the amplifiers.

18. A transmission module comprising:
a splitter unit connected to a plurality of light sources and formed by combining a plurality of splitters;
a plurality of amplifiers configured to amplify a plurality of beams outputted from the splitter unit; and
the modulation system of claim 16 disposed in a subsequent stage of the amplifiers.

19. A transmission module comprising:
a plurality of light sources;
a splitter unit connected to the light sources and formed by combining a plurality of splitters;
a plurality of amplifiers configured to amplify a plurality of beams outputted from the splitter unit; and
the modulation system of claim 16 disposed in a subsequent stage of the amplifiers,
wherein the light sources are divided into a plurality of groups including a group of the three or more light sources, and
wherein wavelengths of beams emitted from the three or more light sources included in the group are set such that a non-interference condition is satisfied, the non-interference condition being that when any two different sets of two wavelengths are selected from all wavelengths included in a beam inputted to one of the amplifiers, the two wavelengths forming one of the two sets and the two wavelengths forming the other set have different frequency differences.

20. A transmission module comprising:
a plurality of light source systems each comprising a main light source and a backup light source;
a splitter unit connected to the light source systems and formed by combining a plurality of splitters;
a plurality of amplifiers configured to amplify a plurality of beams outputted from the splitter unit; and
the modulation system of claim 16 disposed in a subsequent stage of the amplifiers,
wherein the light source systems each comprise a selection unit including a first waveguide having one end connected to the main light source and a second waveguide having one end connected to the backup light source, and
wherein the selection unit comprises:
a switching unit optically coupled to the first waveguide and the second waveguide;
a monitoring unit connected to another end of the first waveguide; and
a redundant processing unit configured to control the switching unit.

21. A transmission module comprising:
a splitter unit connected to a plurality of light sources, the light sources being divided into groups so that wavelengths of beams emitted from the light sources do not overlap each other, the splitter unit comprising a plurality of cascade-connected splitters associated with the groups;
a plurality of amplifiers connected to the splitters disposed in a latter stage of the splitter unit;
a plurality of sorters connected to the amplifiers; and a modulation system comprising a plurality of modulators connected to the sorters associated with the different groups,
wherein the modulators each comprise:
a plurality of modulation units each comprising three or more ring modulators having resonance frequencies adjusted to correspond to three or more different wavelengths; and
an output waveguide configured to multiplex beams that have passed through the ring modulators included in the modulation units and output a multiplexed beam,
wherein the modulation units each comprise a sorting waveguide configured to guide a beam inputted from outside to the ring modulators,
wherein the ring modulators included in each of the modulators have the resonance frequencies adjusted to differ from each other, and
wherein the three or more ring modulators included in each of the modulation units have the resonance frequencies adjusted so that when any two different sets of two wavelengths are selected from the wavelengths corresponding to the resonance frequencies, the two wavelengths forming one of the two sets and the two wavelengths forming the other set have different frequency differences.
